(19) United States
(12) Patent Application Publication
(10) Pub. No.: US 2021/0105167 A1
(43) Pub. Date: Apr. 8, 2021

(54) AUDIO TRANSMISSION AND RECEPTION

(71) Applicant: XiNow Ltd., Kadima-Zoran (IL)

(72) Inventors: Alon Eilam, Kadima-Zoran (IL); Rachel Eilam, Kadima-Zoran (IL)

(73) Assignee: XiNow Ltd., Kadima-Zoran (IL)

(21) Appl. No.: 15/733,165

(22) PCT Filed: Nov. 20, 2018
(86) PCT No.: PCT/IL2018/051259

§ 371 Date: Jun. 2, 2020

Related U.S. Application Data
(60) Provisional application No. 62/595,080, filed on Dec. 6, 2017.

(51) Int. Cl. H04L 27/30; H04B 11/00; H04L 1/00; G10L 25/18

(52) U.S. Cl. CPC H04L 27/30; G10L 25/18; H04L 1/0061; H04B 11/00

(57) ABSTRACT

A method for audio transmission, the method may include receiving or generating a symbol of R bits; selecting a subset of K audio carrier frequencies that represent the symbol; wherein the subset is selected out of a set of N audio carrier frequencies; and concurrently transmitting the subset. (I); Floor is a floor function, and Log₂ is a base two logarithm.

### CROSS REFERENCE

This application claims priority from U.S. provisional patent Ser. No. 62/595,080, filing date Dec. 6, 2017 which is incorporated herein in its entirety.

### BACKGROUND

Digital communication through acoustic signals is limited by interferences, dynamically changing environment and limited broadcast range.

There is a growing need to provide a robust method for Positioning and Data communication over audio.

### SUMMARY

The summary is not intended to limit the breadth of the disclosure.

There are provided systems, methods and computer program products, as illustrated in the claims and the specification.

There may be provided a computer program product that stores instructions for receiving or generating a symbol of R bits; selecting a subset of K audio carrier frequencies that represent the symbol; wherein the subset may be selected out of a set of N audio carrier frequencies; and concurrently transmitting the subset; wherein

$$R = Floor ( {Log}_{2} ( \frac{N !}{K ! ( N - K ) !} ) ) ;$$

Floor may be a floor function, and Log₂ may be a base two logarithm.

There may be provided a transmitter. The transmitter may include one or more circuits that are configured to (i) receive or generate a symbol of R bits; (ii) select a subset of K audio carrier frequencies that represent the symbol; wherein the subset may be selected out of a set of N audio carrier frequencies; and (iii) concurrently transmit the subset; wherein

$$R = Floor ( {Log}_{2} ( \frac{N !}{K ! ( N - K ) !} ) ) ;$$

Floor may be a floor function, and Log₂ may be a base two logarithm.

There may be provided a method for audio transmission, the method may include receiving or generating a symbol of R bits; selecting a subset of K audio carrier frequencies that represent the symbol; wherein the subset may be selected out of a set of N audio carrier frequencies; and concurrently transmitting the subset; wherein

$$R = Floor ( {Log}_{2} ( \frac{N !}{K ! ( N - K ) !} ) ) ;$$

Floor may be a floor function, and Loge may be a base two logarithm.

Each audio carrier frequency of the subset may represent a set bit of the symbol; wherein a value represented by the set bit may be responsive to an order (k) of the set bit within the K set bits of the symbol, and to an order (n) of the set bit within the set of N audio carrier frequencies; wherein for k that ranges between 1 and K and for n that ranges between 0 and N−1, the value of the set bit may be zero for n that may be smaller than n, may be one for n=k, and for n that may exceed k may be

$$( \frac{n !}{k ! ( n - k ) !} ) .$$

The method may include determining, which bit to set to provide K set bits by accessing a mapping that maps values of the set bit to values of n and k.

The method may include finding a group of pairs of N and K values that fulfill

$$R = Floor ( {Log}_{2} ( \frac{N !}{K ! ( N - K ) !} ) ) ;$$

finding a sub-group of pairs of N and K that include a smallest value of K; and selecting, from the sub-group, a pair that includes the smallest value of K and a smallest value of N.

Each audio carrier frequency equals

$$q \cdot \frac{{F}_{s}}{L} ;$$

wherein Fₛ may be a sampling rate of a receiver that may be scheduled to receive the set, L may be a number of samples in a receiver spectral analysis block, and q may exceed zero and may be smaller than a half of L.

R may exceed four.

The method may include changing a value of R to provide a new value of R, and determining K in response to the new value of R.

The symbol may include data bits and error detection bits.

The method may include concurrently transmitting the subset during a symbol transmission duration that ranges between 0.1 and 4 seconds.

The method may include receiving or generating multiple symbols of R bits; selecting multiple subsets of K audio carrier frequencies that represent the multiple symbols; and transmitting the multiple subsets, one subset at a time; wherein a transmission of each subset may include concurrently transmitting a subset that may represent the symbol.

The method may include gradually changing frequencies between a given subset to another subset that follows the given subset, the other subset differs by at least one audio frequency carrier from the given subset.

The multiple subsets belong to the set of N audio carrier frequencies.

At least two subsets of the multiple subsets may belong to different sets of N audio carrier frequencies.

The multiple subsets may start by a first subset and end by a last subset, wherein the method may include: gradually increasing, at a start of the first subset, an amplitude of the first subset; and gradually decreasing, at an end of the last subset, an amplitude of the last subset.

The method may include selecting subsets of K audio carrier frequencies that represent the symbol; wherein each subset belongs to a different set of N audio carrier frequencies; and transmitting the subsets, one subset at a time.

There may be provided a computer program product that stores instructions for concurrently receiving a subset of K carrier frequencies that represent a symbol of R bits; wherein subset was selected out of a set of N audio carrier frequencies; and wherein

$$R = Floor ( {Log}_{2} ( \frac{N !}{K ! ( N - K ) !} ) ) ;$$

Floor may be a floor function, and Log₂ may be a base two logarithm; and reconstructing the symbol to provide a reconstructed symbol, based on the subset.

There may be provided a receiver. The receiver may include one or more circuits that are configured to (i) concurrently receive a subset of K carrier frequencies that represent a symbol of R bits; wherein subset was selected out of a set of N audio carrier frequencies; and wherein

$$R = Floor ( {Log}_{2} ( \frac{N !}{K ! ( N - K ) !} ) ) ;$$

Floor may be a floor function, and Log₂ may be a base two logarithm; and (ii) reconstruct the symbol to provide a reconstructed symbol, based on the subset.

There may be provided a method for audio reception, the method may include: concurrently receiving a subset of K carrier frequencies that represent a symbol of R bits; wherein subset was selected out of a set of N audio carrier frequencies; and wherein

$$R = Floor ( {Log}_{2} ( \frac{N !}{K ! ( N - K ) !} ) ) ;$$

Floor may be a floor function, and Log₂ may be a base two logarithm; and reconstructing the symbol to provide a reconstructed symbol, based on the subset.

Each audio carrier frequency may equal

$$q \cdot \frac{{F}_{s}}{L} ;$$

wherein Fₛ may be a sampling rate of the receiver, L may be a number of samples in a receiver spectral analysis block, and q may exceed zero and may be smaller than a half of L.

The method may include receiving multiple subsets of concurrently transmitted K carrier frequencies, one subset at a time; wherein the multiple subsets represent multiple symbols; wherein each subset was selected out of a set of N audio carrier frequencies; and reconstructing each one of the multiple symbols based on the multiple subsets.

At least two subsets of the multiple subsets may belong to different sets of N audio carrier frequencies.

The subset may represent a set bit of the symbol; wherein a value represented by the set bit may be responsive to an order (k) of the set bit within the K set bits of the symbol, and to an order (n) of the set bit within the set of N audio carrier frequencies; wherein for k that ranges between 1 and K and for n that ranges between 0 and N−1, the value of the set bit may be zero for n that may be smaller than k, may be one for n=k, and for n that may exceed k may be

$$( \frac{n !}{k ! ( n - k ) !} ) .$$

The method may include calculating a value of the reconstructed symbol by accessing, for each set bit, a mapping between a value represented by the set bit and values of k and n.

Each reconstructed symbol may include reconstructed data bits and reconstructed error detection bits; wherein the method may include performing error detecting using the reconstructed error detection bits.

The method may include selecting K frequency components of a spectrum of the subset of N carrier frequencies as set bits of a suggested symbol; performing error detection on the suggested symbol; wherein if the error detection indicated that the suggested symbol may be erroneous—then replacing at least one selected frequency component by another frequency component that was not previously selected thereby providing a newly selected symbol and performing error detection on the newly suggested symbol.

The method may include setting K to a number of frequency components, in the spectrum of the subset of N carrier frequencies, having an intensity that may exceed a predefined intensity threshold.

The method may include transmitting over a non-audio link, information about the reconstructed symbol.

The reconstructed symbol may embed a command executable by a remote computer.

The method may include receiving, over a non-audio-link message that may include a verification code; generating information about the verification code and the reconstructed message.

The method may include concurrently receiving the subset of K carrier frequencies and additional audio signals; wherein reconstructed symbol may include metadata regarding the additional audio signals.

The symbol may include information about a location of the transmitter.

The symbol may include information about an identity of the transmitter. The method may include the obtaining information about the identity of the transmitter and calculating, based on the reconstructed symbol, a location of the receiver.

The transmitter may be an internet protocol phone. The symbol may include information about an identity of the internet protocol phone; wherein the method may include: obtaining information about the identity of the internet protocol phone; supplying to a remote computer a phone number of a target device; and sending a request, to the remote computer, to establish a communication session between the internet protocol phone and the target device.

The method may include a clock frequency compensation by evaluating different frequency shifted subsets of frequency components of a spectrum of the subset of K carrier frequencies.

The method may include averaging the frequency component amplitude with the amplitudes of adjacent frequency components on the receiver DFT grid.

At least one carrier frequency (some or all of the carrier frequencies) may be a non-audio carrier frequency.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is an example of a symbol;

FIG. 2 is an example of a transmitter and of a receiver;

FIG. 3 illustrates an example symbols and encoding of symbols, represented in registers;

FIG. 4 illustrates examples of waveforms of four carrier frequencies;

FIG. 5 illustrates an example of a waveform of an encoded symbol;

FIG. 6 is a spectrum of an encoded symbol;

FIG. 7 is an example of a spectrum that exhibits good sparsity;

FIG. 8 is an example of a spectrum that exhibits an ill sparsity;

FIG. 9 is an example of a method for encoding;

FIG. 10 illustrates an example of a method for decoding;

FIG. 11 illustrates an example of a spectrum of four carrier frequencies and noise;

FIG. 12 illustrates an example of a spectrum of three carrier frequencies and noise;

FIG. 13 illustrates an example of a gradual frequency change of amplitude and frequency;

FIG. 14 illustrates an example of a system;

FIG. 15 illustrates an example of a secured login to e-Banking services;

FIG. 16 illustrates an example of an Annotation of an audio signal by an Amplitude Modulated encoded Symbol;

FIG. 17 illustrates an example of a transmission of beacons;

FIG. 18 illustrates an example of a system;

FIG. 19 illustrates an example of a system;

FIG. 20 illustrates an example of a method; and

FIG. 21 illustrates an example of a method.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a computer program product that stores instructions that once executed by a computer result in the execution of the method.

Any reference in the specification to a system and any other component should be applied mutatis mutandis to a method that may be executed by the memory device and should be applied mutatis mutandis to a computer program product that stores instructions that may be executed by the memory device.

Any reference in the specification to a computer program product should be applied mutatis mutandis to a system capable of executing the instructions stored in the computer program product and should be applied mutatis mutandis to method that may be executed by a computer that reads the instructions stored in the computer program product.

Any combination of any module or unit listed in any of the figures, any part of the specification and/or any claims may be provided. Especially any combination of any claimed feature may be provided.

The terms “symbol” and “encoded symbol” may be used in an interchangeable manner Encoding maps a field of 2\hat{ }R values to a field of 2\hat{ }N values. Symbols belong to the first field, Encoded Symbols belong to the second field.

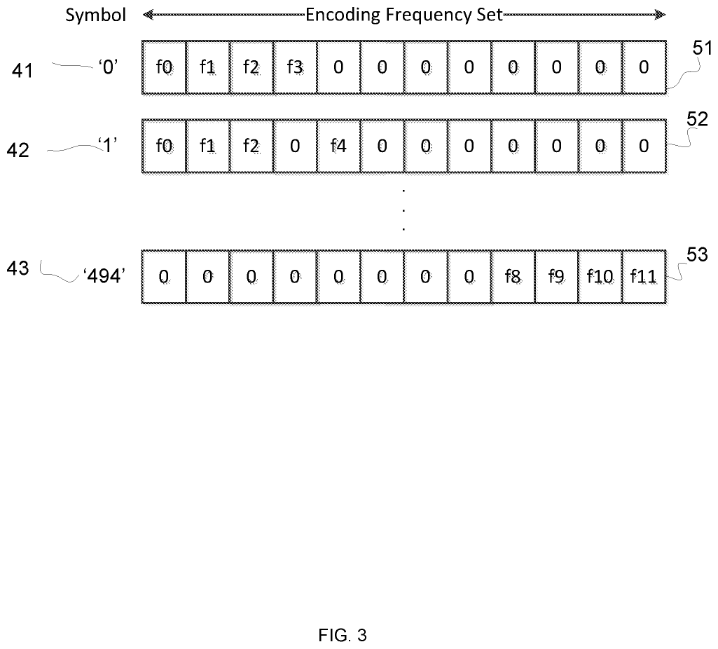

For example, as illustrated in FIG. 3: the symbols range is 0 to 494 (in practice we use only 0-255 for R=8)—the encoded symbols (referred to in FIG. 3 as “Encoding Frequency Set”) are represented by 12 bits register, corresponding to a field with 4096 values.

There may be provided a method for data communication over an acoustic channel, where Loudspeakers and a Microphones are transmitting and receiving Acoustic signals accordingly.

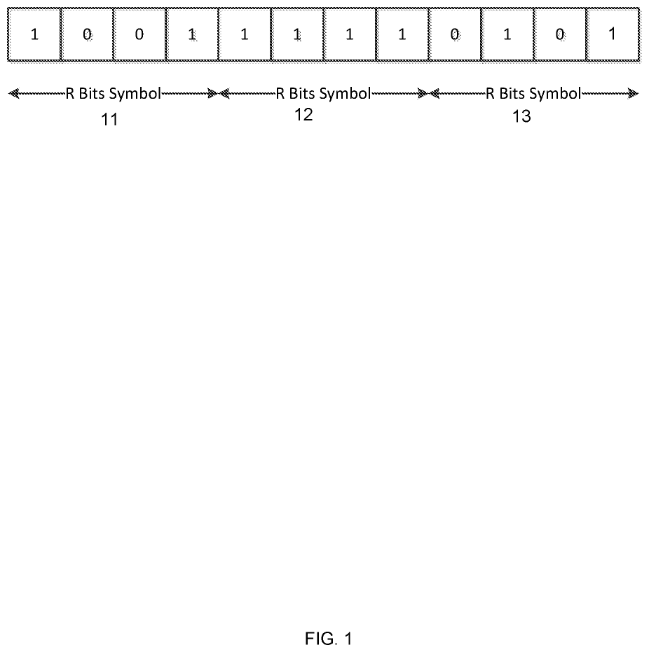

The data to be delivered is a sequence of ‘0’ and ‘1’ bits. Consecutive sets of R bits of the binary sequence are grouped into Symbols, and a sequence of Symbols is constructing a Message as depicted in FIG. 1. FIG. 1 includes a sequence of three R bits symbols 11, 12 and 13.

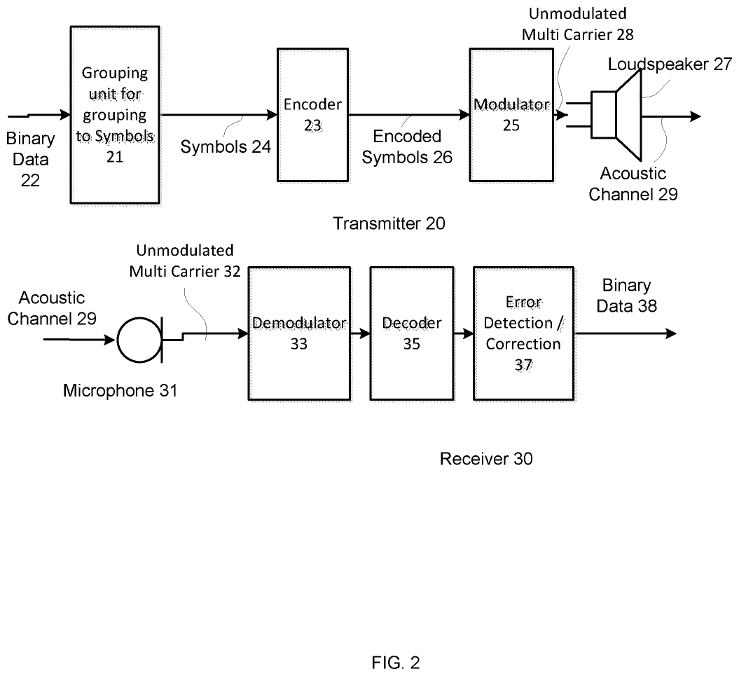

FIG. 2 illustrates a receiver and transmitter. FIG. 2 illustrates examples of one or more circuits of the receiver and one or more circuits of the transmitter.

In the transmitter 20, binary data 22 is grouped to symbols 24 by grouper 21. Each symbol is encoded (by encoder 23) and modulated (by modulator 25) to provide unmodulated Multi Carriers 28 that are fed to a digital to analog converter (not shown). The analog signal is transmitted by the loudspeaker 27 over an acoustic channel 29.

Microphone 31 of receiver 30 receives the Unmodulated Multi Carriers 28. At the Receiver a demodulator (that may include an Analog to Digital Converter that samples the Microphone signal), a decoder 35 decodes it in order to extract the binary data sequence, optionally following error detection/correction (37) to provide binary data 38.

Unmodulated Multi Carrier method is based on transmitting concurrently K out of N possible frequencies per each Symbol.

Thus the number of different Symbols per selection of K and N parameters is

$$M = ( \frac{N !}{K ! ( N - K ) !} ) .$$

Accordingly, the number of bits per Symbol is

$$R = ⌊ {log}_{2} ( M ) ⌋ [ \frac{Bits}{Symbol} ] .$$

An example for K=4, N=12 resulting in M=495 where

$$R = ⌊ {log}_{2} ( 495 ) ⌋ = 8 [ \frac{Bits}{Symbol} ]$$

is depicted in FIG. 3.

Encoding of three symbols out of a larger group of symbols having values of zero to four hundred and ninety-four (41-43) is represented by register values 51-53.

The Data Rate between a Transmitter and a Receiver is:

$$Data Rate [ \frac{Bits}{Second} ] = Symbol Rate [ \frac{Symbols}{Second} ] \cdot R [ \frac{Bits}{Symbol} ]$$

Where the values of K and N in the Unmodulated Multi Carrier method determine the value of R:

$$R = ⌊ {log}_{2} ( M ) ⌋ [ \frac{Bits}{Symbol} ] , M = ( \frac{N !}{K ! ( N - K ) !} ) .$$

From the above equation it is apparent that different values of K and N may provide the same R value. Table 1 is constructed by using the above equation, and provide a demonstration of this property. The consideration for optimal selection of K and N for a desired value of R bits per Symbol is that smaller values of K and N provide better Noise Immunity and Receiving Frequency Specificity.

Noise Immunity is defined herein as the Signal to Noise ratio at which the received binary data bit error rate is within permissible limits.

The lower the level of Signal to Noise ratio at which the receiver maintains its permissible bit error rate limits, the higher is its Noise Immunity.

For Unmodulated Multi Carrier encoding method, Noise Immunity improves when K is smaller since the overall transmitted energy is allocated to a smaller number of Carriers, and thus the Signal to Noise ratio per carrier is higher. Receiving Frequency Specificity is defined herein as the independency of energy at one frequency, measured through Spectral Analysis, of the energy at other frequencies.

The Receiving Frequency Specificity is proportional to

$$\frac{Overall Transmiter Bendwidth}{N} [ Hz ]$$

and thus a smaller value of N results in better Specificity. The method for optimal selection of K and N for a given value of R Bits per Symbol is to use Table 1, and choose the minimum value of K which provides the desired R value.

Once the value of K is determined, the minimal value of N which provides the required R value shall be chosen.

As an example, for R value of 9 Bits per Symbol, an optimal combination of K and N is K=3 N=16. Other combinations such as K=4 N=12 are sub-optimal.

If the desired value of R is greater than the values listed in Table 1, a larger table which includes the desired R value shall be constructed by using the equations above.

TABLE 1
Bits per Symbol for N in the range [2 . . . 32] and K in the range [1 . . . ┌ N/2┐].

| | K | | | | | | | | | | | | | | | |
|---|---|---|---|---|---|---|---|---|---|---|---|---|---|---|---|---|
| N | 1 | 2 | 3 | 4 | 5 | 6 | 7 | 8 | 9 | 10 | 11 | 12 | 13 | 14 | 15 | 16 |
| 2 | 1 | | | | | | | | | | | | | | | |
| 3 | 1 | 1 | | | | | | | | | | | | | | |
| 4 | 2 | 2 | | | | | | | | | | | | | | |
| 5 | 2 | 3 | 3 | | | | | | | | | | | | | |
| 6 | 2 | 3 | 4 | | | | | | | | | | | | | |
| 7 | 2 | 4 | 5 | 5 | | | | | | | | | | | | |
| 8 | 3 | 4 | 5 | 6 | | | | | | | | | | | | |
| 9 | 3 | 5 | 6 | 6 | 6 | | | | | | | | | | | |
| 10 | 3 | 5 | 6 | 7 | 7 | | | | | | | | | | | |
| 11 | 3 | 5 | 7 | 8 | 8 | 8 | | | | | | | | | | |
| 12 | 3 | 6 | 7 | 8 | 9 | 9 | | | | | | | | | | |
| 13 | 3 | 6 | 8 | 9 | 10 | 10 | 10 | | | | | | | | | |
| 14 | 3 | 6 | 8 | 9 | 10 | 11 | 11 | | | | | | | | | |
| 15 | 3 | 6 | 8 | 10 | 11 | 12 | 12 | 12 | | | | | | | | |
| 16 | 4 | 6 | 9 | 10 | 12 | 12 | 13 | 13 | | | | | | | | |
| 17 | 4 | 7 | 9 | 11 | 12 | 13 | 14 | 14 | 14 | | | | | | | |
| 18 | 4 | 7 | 9 | 11 | 13 | 14 | 14 | 15 | 15 | | | | | | | |
| 19 | 4 | 7 | 9 | 11 | 13 | 14 | 15 | 16 | 16 | 16 | | | | | | |
| 20 | 4 | 7 | 10 | 12 | 13 | 15 | 16 | 16 | 17 | 17 | | | | | | |
| 21 | 4 | 7 | 10 | 12 | 14 | 15 | 16 | 17 | 18 | 18 | 18 | | | | | |
| 22 | 4 | 7 | 10 | 12 | 14 | 16 | 17 | 18 | 18 | 19 | 19 | | | | | |
| 23 | 4 | 7 | 10 | 13 | 15 | 16 | 17 | 18 | 19 | 20 | 20 | 20 | | | | |
| 24 | 4 | 8 | 10 | 13 | 15 | 17 | 18 | 19 | 20 | 20 | 21 | 21 | | | | |
| 25 | 4 | 8 | 11 | 13 | 15 | 17 | 18 | 20 | 20 | 21 | 22 | 22 | 22 | | | |
| 26 | 4 | 8 | 11 | 13 | 16 | 17 | 19 | 20 | 21 | 22 | 22 | 23 | 23 | | | |
| 27 | 4 | 8 | 11 | 14 | 16 | 18 | 19 | 21 | 22 | 23 | 23 | 24 | 24 | 24 | | |
| 28 | 4 | 8 | 11 | 14 | 16 | 18 | 20 | 21 | 22 | 23 | 24 | 24 | 25 | 25 | | |
| 29 | 4 | 8 | 11 | 14 | 16 | 18 | 20 | 22 | 23 | 24 | 25 | 25 | 26 | 26 | 26 | |
| 30 | 4 | 8 | 11 | 14 | 17 | 19 | 20 | 22 | 23 | 24 | 25 | 26 | 26 | 27 | 27 | |
| 31 | 4 | 8 | 12 | 14 | 17 | 19 | 21 | 22 | 24 | 25 | 26 | 27 | 27 | 27 | 28 | 28 |
| 32 | 5 | 8 | 12 | 15 | 17 | 19 | 21 | 23 | 24 | 25 | 26 | 27 | 28 | 28 | 29 | 29 |

As an example, for R value of 9 Bits per Symbol, an optimal combination of K and N is K=3 N=16.

Other combinations such as K=4 N=12 are sub-optimal. If the desired value of R is greater than the values listed in Table 1, a larger table which includes the desired R value shall be constructed by using the equations above.

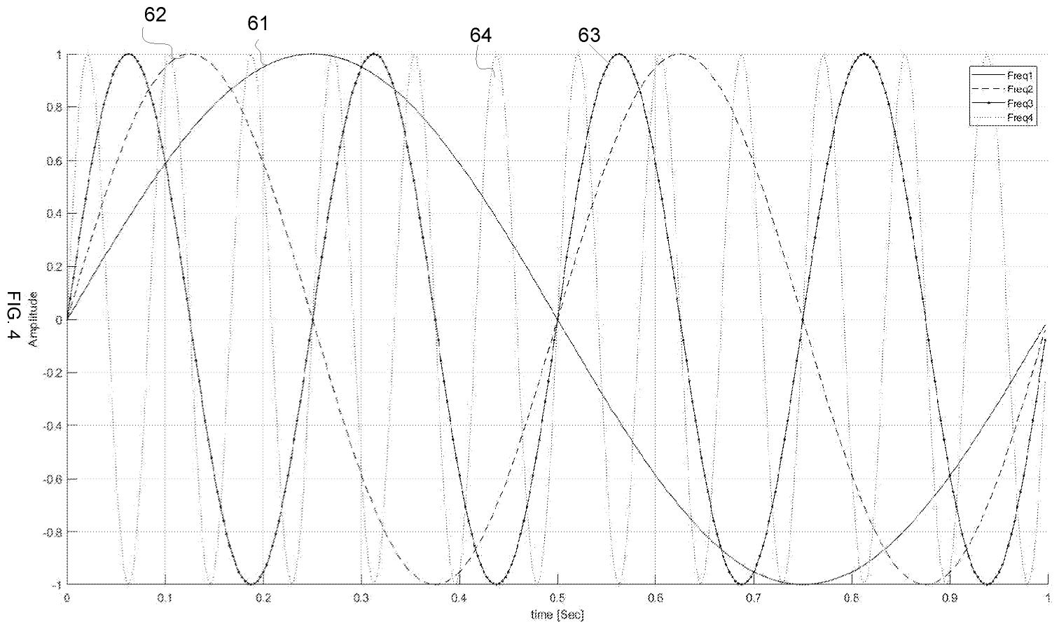

The optimal method to set the Symbols duration in time is to consider the Receiver Spectral Analysis block size—especially setting the duration of a symbol to a single or multiple of the Receiver Spectral Analysis block size. It is required that per each of the N frequencies, an integer number of cycles shall be contained within the Receiver Spectral Analysis block, as depicted in FIG. 4. This method provides better Receiver performance due to high sparsity of the received signal in the frequency domain following Spectral Analysis.

FIG. 4 illustrates waveforms of four carrier frequencies 61, 62, 63 and 64 within a Receiver Spectral Analysis block duration of 1 second.

In FIG. 4, Signals composing a Symbol with K=4 N=16. The signals frequencies are selected so that an integer number of cycles of each signal is contained within the Receiver Spectral Analysis block.

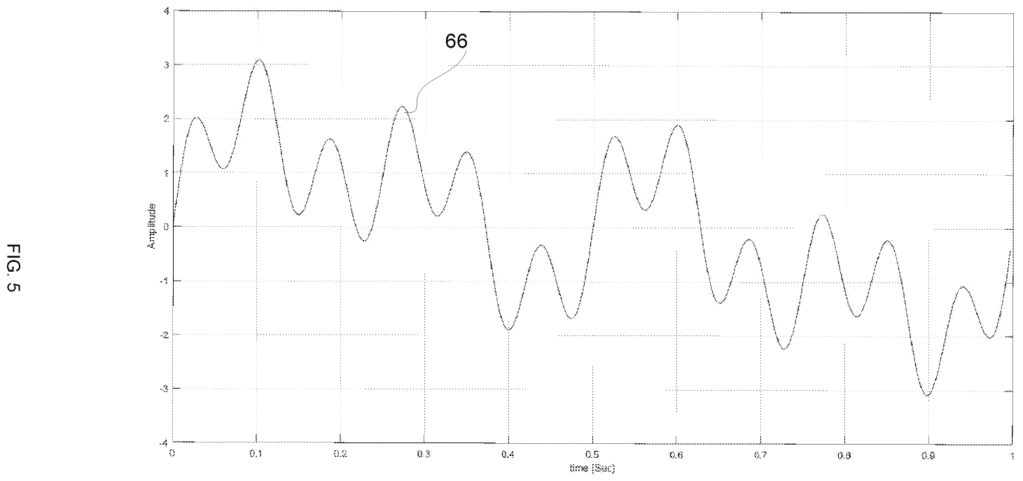

FIG. 5 illustrates a waveform of an encoded symbol 66 that is a sum of carrier frequencies 61-64 of FIG. 4.

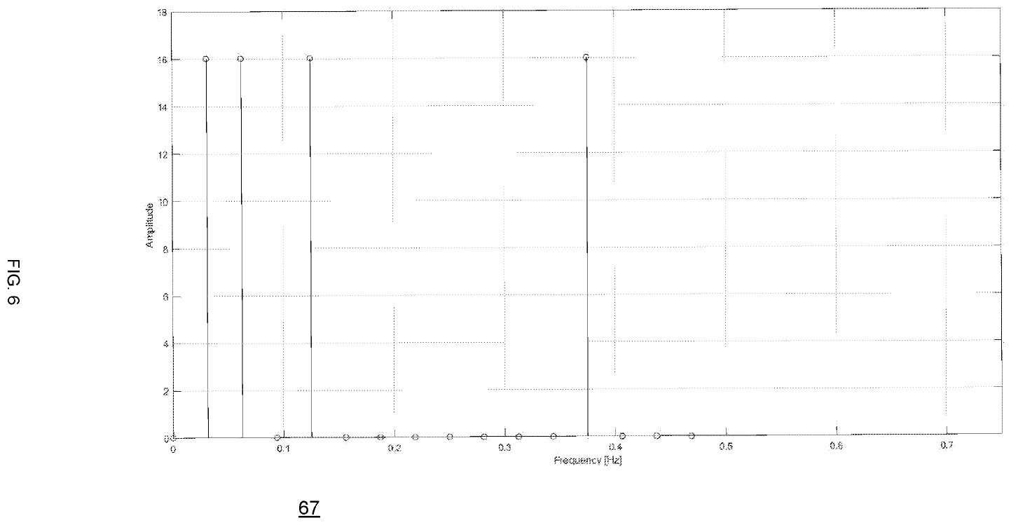

FIG. 6 is a spectrum of the encoded symbol 66 of FIG. 5 at the Receiver.

The N frequencies out of which K are used by the Transmitter per each Symbol are designed to be on the Receiver DFT grid:

$${f}_{q} = q \cdot \frac{{F}_{s}}{L} ,$$

where Fₛ is the receiver sampling rate, L is the number of samples in the Receiver Spectral Analysis block and n is an integer in the range 0<q<L/2.

The selection of N frequencies out of the set {f_{q}} provides excellent Receiving Frequency Specificity and high Noise Immunity due to received signals sparsity in the Spectral Analysis domain

The subset of N frequencies out of {f_{q}} used per Unmodulated Multi Carrier communication is determined by the audio frequency band at which communication shall take place, such as inaudible frequencies, quite areas of the spectrum and Microphones and Loudspeakers characteristics.

It is required to keep a distance of at least 2 between the frequency indices in the subset of N frequencies used out of the set {f_{q}} to provide tolerance for the Spectral Analysis performed by the Receiver.

As an example, only a subset of size N with odd q values or even q values shall be used out of the set {f_{q}}. A method by which an integer number of cycles is contained within the Receiver Spectral Analysis block, assures that the transmitted frequencies will be on the Receiver DFT grid.

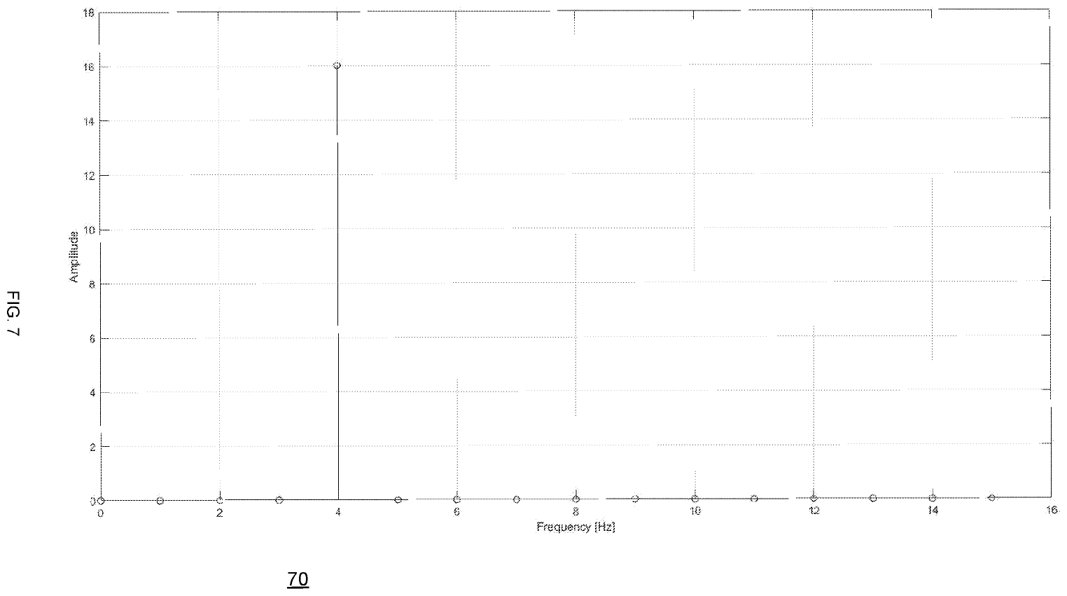

FIG. 7 is a spectrum of a Symbol with Fₛ=32, L=32, K=1, N=4. The symbol exhibits an excellent sparsity with proper selection of a Symbol frequencies set on the Receiver DFT grid.

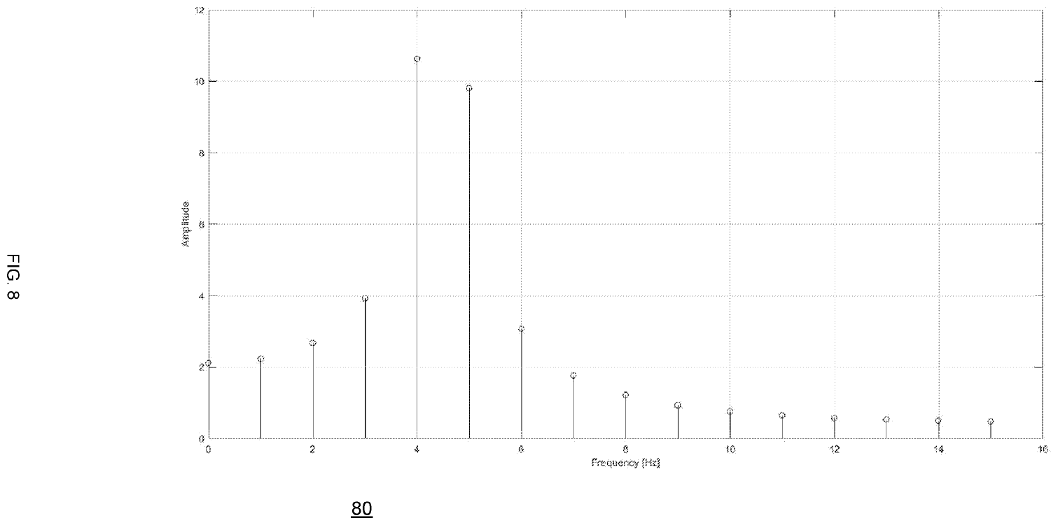

FIG. 8 depicts a spectrum 80 that exhibits an ill sparsity when the frequency of a Symbol with Fₛ=32, L=32, K=1, N=4 is off the Receiver's DFT grid.

A method may be provided to overcome Inter Symbol interference due to Acoustic Echo by applying Frequency Hopping scheme, where a set N (which is merely a subgroup of the group of {f_{q}} frequencies of the Receiver DFT grid) is used per a Symbol transmission, while the following symbol in the message is transmitted using a different and mutually exclusive sets N of the {f_{q}} frequencies of the receiver DFT grid. After transmitting several Symbols, typically between 2 and 4, the first set of N frequencies is used again in a circular manner

Concurrent communication of several users in the vicinity of each other is provided by using different sets of N mutually exclusive frequencies out of the {f_{q}} on the Receiver DFT grid, where each pair of users is communicating over their own set of N frequencies without disturbing the other users.

The method of using subsets of frequencies of the Receiver DFT grid provides for full duplex operation where bi-directional communication between users can be performed.

The N frequencies in use may be selected in a frequency range at the edge or beyond the human hearing range, providing for inaudible acoustic communication between devices. This method is highly applicable to cellular phones where most Loudspeakers and Microphones can transmit and receive in these frequencies with adequate sampling rate of 44100 samples per second or higher.

In classic Binary Coding, a value encoded in N-bits register is provided by: Σₙ₌₀^{N-1} bₙPₙ where Pₙ=2ⁿ, and bₙ is the binary value of the bit with index n, with bits indexing in the range [0 . . . N−1]. In classic Binary Coding the bits binary values are independent of each other.

In Unmodulated Multi Carrier encoding as illustrated in the current application, since exactly K frequencies are transmitted per each Symbol, the K concurrently transmitted frequencies out of N may be referred to as K bits with value ‘1’ and N−K bits with value ‘0’ in an N bits register. To calculate the encoded value, the K bits with value ‘1’ are indexed [1 . . . K] in the same order as the register bits positions are indexed. Applying this indexing method, the encoded symbol equals:

$${\sum }_{k = 1}^{K} {P}_{k , n} where {P}_{k , n} = \{ \begin{matrix}( \frac{n !}{k ! ( n - k ) !} ) for n \geq k \\ 0 for n < k\end{matrix}$$

As an example, Unmodulated Multi Carrier encoding with parameters K=3, N=7 is provided in Table 2.

Table 2 provides a straight forward method Symbol Encoding and Decoding Lookup Table, for K=3 N=7. A different table, consuming additional memory, is required per each selection of K and N.

TABLE 2

| Symbol | bit 6 | bit 5 | bit 4 | bit 3 | bit 2 | bit 1 | bit 0 |
|---|---|---|---|---|---|---|---|
| 0 | 0 | 0 | 0 | 0 | 1 | 1 | 1 |
| 1 | 0 | 0 | 0 | 1 | 0 | 1 | 1 |
| 2 | 0 | 0 | 0 | 1 | 1 | 0 | 1 |
| 3 | 0 | 0 | 0 | 1 | 1 | 1 | 0 |
| 4 | 0 | 0 | 1 | 0 | 0 | 1 | 1 |
| 5 | 0 | 0 | 1 | 0 | 1 | 0 | 1 |
| 6 | 0 | 0 | 1 | 0 | 1 | 1 | 0 |
| 7 | 0 | 0 | 1 | 1 | 0 | 0 | 1 |
| 8 | 0 | 0 | 1 | 1 | 0 | 1 | 0 |
| 9 | 0 | 0 | 1 | 1 | 1 | 0 | 0 |
| 10 | 0 | 1 | 0 | 0 | 0 | 1 | 1 |
| 11 | 0 | 1 | 0 | 0 | 1 | 0 | 1 |
| 12 | 0 | 1 | 0 | 0 | 1 | 1 | 0 |
| 13 | 0 | 1 | 0 | 1 | 0 | 0 | 1 |
| 14 | 0 | 1 | 0 | 1 | 0 | 1 | 0 |
| 15 | 0 | 1 | 0 | 1 | 1 | 0 | 0 |
| 16 | 0 | 1 | 1 | 0 | 0 | 0 | 1 |
| 17 | 0 | 1 | 1 | 0 | 0 | 1 | 0 |
| 18 | 0 | 1 | 1 | 0 | 1 | 0 | 0 |
| 19 | 0 | 1 | 1 | 1 | 0 | 0 | 0 |
| 20 | 1 | 0 | 0 | 0 | 0 | 1 | 1 |
| 21 | 1 | 0 | 0 | 0 | 1 | 0 | 1 |
| 22 | 1 | 0 | 0 | 0 | 1 | 1 | 0 |
| 23 | 1 | 0 | 0 | 1 | 0 | 0 | 1 |
| 24 | 1 | 0 | 0 | 1 | 0 | 1 | 0 |
| 25 | 1 | 0 | 0 | 1 | 1 | 0 | 0 |
| 26 | 1 | 0 | 1 | 0 | 0 | 0 | 1 |
| 27 | 1 | 0 | 1 | 0 | 0 | 1 | 0 |
| 28 | 1 | 0 | 1 | 0 | 1 | 0 | 0 |
| 29 | 1 | 0 | 1 | 1 | 0 | 0 | 0 |
| 30 | 1 | 1 | 0 | 0 | 0 | 0 | 1 |
| 31 | 1 | 1 | 0 | 0 | 0 | 1 | 0 |
| 32 | 1 | 1 | 0 | 0 | 1 | 0 | 0 |
| 33 | 1 | 1 | 0 | 1 | 0 | 0 | 0 |
| 34 | 1 | 1 | 1 | 0 | 0 | 0 | 0 |

Referring to table 2—the Symbol value 25 is encoded [1 0 0 1 1 0 0]:

| n | 6 | 5 | 4 | 3 | 2 | 1 | 0 |
|---|---|---|---|---|---|---|---|
| r | 3 | 0 | — | 2 | 1 | — | — |
| bit value | 1 | 0 | 0 | 1 | 1 | 0 | 0 |

Computing the Symbol value provides

$$S = ( \frac{6 !}{3 ! ( 6 - 3 ) !} ) + ( \frac{3 !}{2 ! ( 3 - 2 ) !} ) + ( \frac{2 !}{2 ! ( 2 - 1 ) !} ) = 20 + 3 + 2 = 25$$

Referring to table 4—The Symbol value 4 is encoded [0 0 1 0 0 1 1]:

| n | 6 | 5 | 4 | 3 | 2 | 1 | 0 |
|---|---|---|---|---|---|---|---|
| r | — | — | 3 | — | — | 2 | 1 |
| bit value | 0 | 0 | 1 | 0 | 0 | 1 | 1 |

Computing the Symbol value provides:

$$S = ( \frac{4 !}{3 ! ( 4 - 3 ) !} ) + 0 + 0 = 4 + 0 + 0 = 4$$

The transmitter shall transmit concurrently K out of N possible frequencies.

The indexes of the K frequencies are provided to the Transmitter Modulator by an Encoder through a register with N bits, where a bit with value ‘1’ corresponds to a frequency to be transmitted. An efficient method for encoding a Symbol shall implement the equation:

$${\sum }_{k = 1}^{K} {P}_{k , n} where {P}_{r , n} = \{ \begin{matrix}( \frac{n !}{k ! ( n - k ) !} ) for n \geq k \\ 0 for n < k\end{matrix}$$

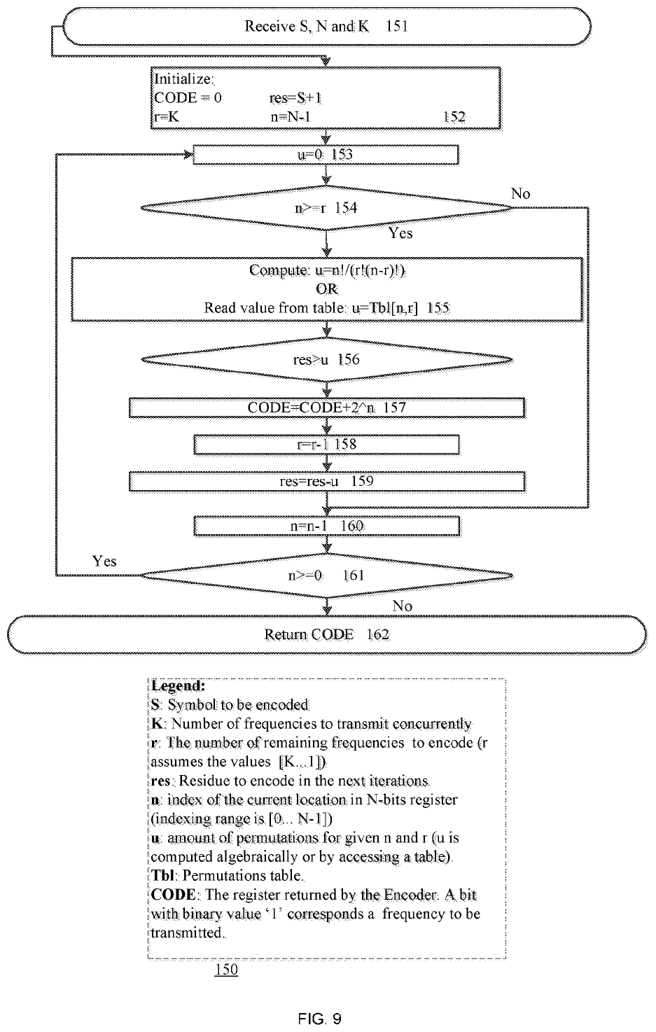

An example of implementation is provided in the flowchart of FIG. 9. In order to reduce the computation complexity the algebraic calculation of

$$( \frac{n !}{k ! ( n - k ) !} )$$

can be replaced by accessing a Permutations table of size N×K.

Table 3 is an example of Permutation table for K=3, N=7.

TABLE 3

| N | k = 1 | k = 2 | k = 3 |
|---|---|---|---|
| 0 | 0 | 0 | 0 |
| 1 | 1 | 0 | 0 |
| 2 | 2 | 1 | 0 |
| 3 | 3 | 3 | 1 |
| 4 | 4 | 6 | 4 |
| 5 | 5 | 10 | 10 |
| 6 | 6 | 15 | 20 |

An efficient method which is based on the above equation achieves a significant gain in terms of memory requirements over a straight-forward method, which is based on accessing a Lookup Table with 2\hat{ }R rows where each row provides the indexes of frequencies to be transmitted per Symbol.

The Receiver shall sample the received analog signal and perform Spectral Analysis of blocks with L samples to get an L complex-valued vector, representing the received signal in the frequency domain Following Spectral Analysis, the amplitudes of the N frequencies used in the Unmodulated Multi Carrier scheme are computed, and the indexes of the largest K frequencies out of N are provided as K bits with value ‘1’ in N bits register to the Decoder, while all the other bits in the register are provided with value ‘0’.

An efficient method for decoding an encoded Symbol shall implement the equation provided above: Σₖ₌₁^{K} P_{k,n} where

$${P}_{k , n} = \{ \begin{matrix}( \frac{n !}{k ! ( n - r ) !} ) for n \geq k \\ 0 for n < k\end{matrix}$$

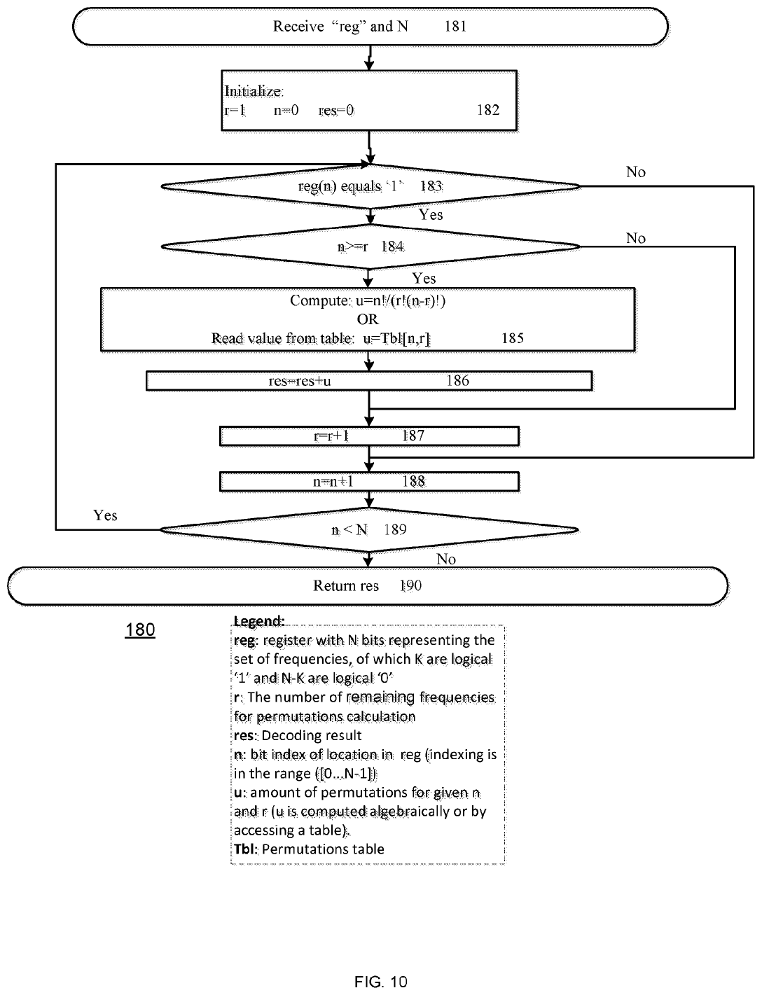

An example of implementation is provided in the flowchart of FIG. 10. In order to reduce the computation complexity the algebraic calculation of

$$( \frac{n !}{k ! ( n - k ) !} )$$

can be replaced by accessing a Permutations table of size N×K.

FIG. 9 is an example of method 150 for encoding. The method includes steps 151-162 for outputting an encoded value given S, N, and K.

In the method:
1) S: Symbol to be encoded
2) K: Number of bits to set to ‘1’, corresponding to the number of frequencies transmitted concurrently
3) k: The number of remaining bits to set to ‘1’ (k assumes the values [K . . . 1])
4) res: Residue to encode in the next iterations
5) n: index of the current location in N-bits register (indexing range is [0 . . . N−1])
6) u: amount of permutations for given n and k (u is computed algebraically or by accessing a table).
7) Tbl: Permutations table.
8) CODE: The register returned by the Encoder. A bit with binary value ‘1’ corresponds a frequency to be transmitted.

Steps 151-162 almost form a sequence of steps—wherein steps 154 and 161 are conditional steps.

Step 151 includes receiving S, N, and K.

Step 152 including an initialization step.

Step 153 includes zeroing u.

Step 154 included checking if n exceeds k. If yes—jumping to step 150—if no jumping to step 160.

Step 155 includes calculating u.

Step 156 includes asking is res>u.

Step 157 includes incrementing CODE by 2 by the power of n.

Step 158 includes decreasing k by one.

Step 159 includes decrementing res by u.

Step 160 include decreasing n by one.

Step 161 includes checking of n exceeds zero. If yes—jumping to step 153. If no—continuing to step 162.

Step 162 includes return CODE.

FIG. 10 illustrates a method 180 for decoding. The method includes steps 181-190 for outputting a decoded value res given reg and N.

In this method:
1) reg: register with N bits representing the set of frequencies, of which K are logical ‘1’ and N−K are logical ‘0’
2) k: The index of bit set to ‘1’. Indexing is in the range [1 . . . k]
3) res: Decoding result
4) n: bit index of location in reg. Indexing is in the range [0 . . . N−1]
5) u: amount of permutations for given n and k (u is computed algebraically or by accessing a table).
6) Tbl: Permutations table

Steps 181-190 almost form a sequence of steps—wherein steps 183, 184 and 188 are conditional steps.

Step 181 includes receiving reg and N.

Step 182 including an initialization step.

Step 183 includes checking if reg(n) equals one (is it a set bit). If yes—jumping to step 184—if no jumping to step 188.

Step 184 includes checking of n exceeds r. If yes—continuing to step 185 and if not—jumping to step 187.

Step 185 includes calculating u.

Step 186 includes incrementing res by u.

Step 187 includes increasing k by one.

Step 188 includes incrementing n by one.

Step 189 includes checking if n is smaller than N. If yes—jumping to step 183. If no—continuing to step 190.

Step 190 includes return res.

An Acoustic channel may cause distortions to frequencies in use, such as unequal attenuation of Symbol frequencies, interference of echo of previous Symbol frequencies or interference of frequencies from sources other than the Transmitter. These and other impairments may cause erroneous Symbols decoding by the Receiver.

There may be provided a method to detect erroneous decoded Symbols and to extend the Hamming distance between encoded Symbols by embedding CRC bits.

At the receiver, the binary decoded Symbol shall include correct CRC bits, otherwise the decoded Symbol shall be considered erroneous.

Table 4 is an example of 6 bits Symbols where 4 bits are data and two bits are CRC, encoded by K=4, N=8.

TABLE 4

| Symbol | d0 | d1 | d2 | d3 | c0 | c1 | f0 | f1 | f2 | f3 | f4 | f5 | f6 | f7 |
|---|---|---|---|---|---|---|---|---|---|---|---|---|---|---|
| 0 | 0 | 0 | 0 | 0 | 0 | 0 | 1 | 1 | 1 | 1 | 0 | 0 | 0 | 0 |
| 1 | 1 | 0 | 0 | 0 | 1 | 1 | 0 | 1 | 0 | 1 | 0 | 1 | 0 | 1 |
| 2 | 0 | 1 | 0 | 0 | 1 | 0 | 0 | 1 | 1 | 1 | 0 | 0 | 1 | 0 |
| 3 | 1 | 1 | 0 | 0 | 0 | 1 | 1 | 1 | 1 | 0 | 0 | 0 | 0 | 1 |
| 4 | 0 | 0 | 1 | 0 | 0 | 1 | 1 | 1 | 0 | 1 | 0 | 0 | 0 | 1 |
| 5 | 1 | 0 | 1 | 0 | 1 | 0 | 0 | 1 | 1 | 0 | 1 | 0 | 1 | 0 |
| 6 | 0 | 1 | 1 | 0 | 1 | 1 | 0 | 0 | 0 | 1 | 1 | 1 | 0 | 1 |
| 7 | 1 | 1 | 1 | 0 | 0 | 0 | 1 | 0 | 1 | 1 | 0 | 1 | 0 | 0 |
| 8 | 0 | 0 | 0 | 1 | 1 | 1 | 1 | 0 | 1 | 0 | 0 | 0 | 1 | 1 |
| 9 | 1 | 0 | 0 | 1 | 0 | 0 | 1 | 1 | 0 | 0 | 1 | 1 | 0 | 0 |
| 10 | 0 | 1 | 0 | 1 | 0 | 1 | 1 | 0 | 0 | 1 | 1 | 0 | 0 | 1 |
| 11 | 1 | 1 | 0 | 1 | 1 | 0 | 0 | 1 | 1 | 0 | 0 | 1 | 1 | 0 |
| 12 | 0 | 0 | 1 | 1 | 1 | 0 | 1 | 0 | 0 | 1 | 0 | 1 | 1 | 0 |
| 13 | 1 | 0 | 1 | 1 | 0 | 1 | 1 | 1 | 0 | 0 | 0 | 1 | 0 | 1 |
| 14 | 0 | 1 | 1 | 1 | 0 | 0 | 0 | 0 | 1 | 1 | 1 | 1 | 0 | 0 |
| 15 | 1 | 1 | 1 | 1 | 1 | 1 | 0 | 0 | 1 | 0 | 1 | 0 | 1 | 1 |

Example of encoded Symbols with Hamming Distance 4. Two CRC bits (c0, c1) are appended to 4 bits data (d0-d3) to provide 6 bits, encoded with K=4, N=8.

There may be provided a method for error correction of received encoded Symbol. When the K highest energy frequencies out of N frequencies detected by Spectral Analysis at the Receiver result with wrong CRC bits, the K^{th} highest energy frequency index shall be replaced by the (K+1)^{th} highest energy frequency index, and CRC computation shall be tried again.

If the new computed CRC is correct, then the reception error was corrected. Otherwise the Symbol shall be considered erroneous.

The data rate between a Transmitter and a Receiver is:

$$Data Rate ⌊ \frac{Bits}{Second} ⌋ = Symbol Rate [ \frac{Symbols}{Second} ] \cdot R [ \frac{Bits}{Symbol} ]$$

There may be provided a method for Automatic Data Rate detection at the Receiver, so that the transmitter may transmit at variable data rate by setting the number of frequencies K per Symbol without notifying the Receiver, and the Receiver may automatically detect the Data Rate in use.

This method is based on comparing the ratio between the energy of the received frequencies, and requiring that their ratio shall be within a pre-defined range such as +/−10 dB. The number of frequencies with amplitude ratio within this range equals the parameter K used by the Transmitter.

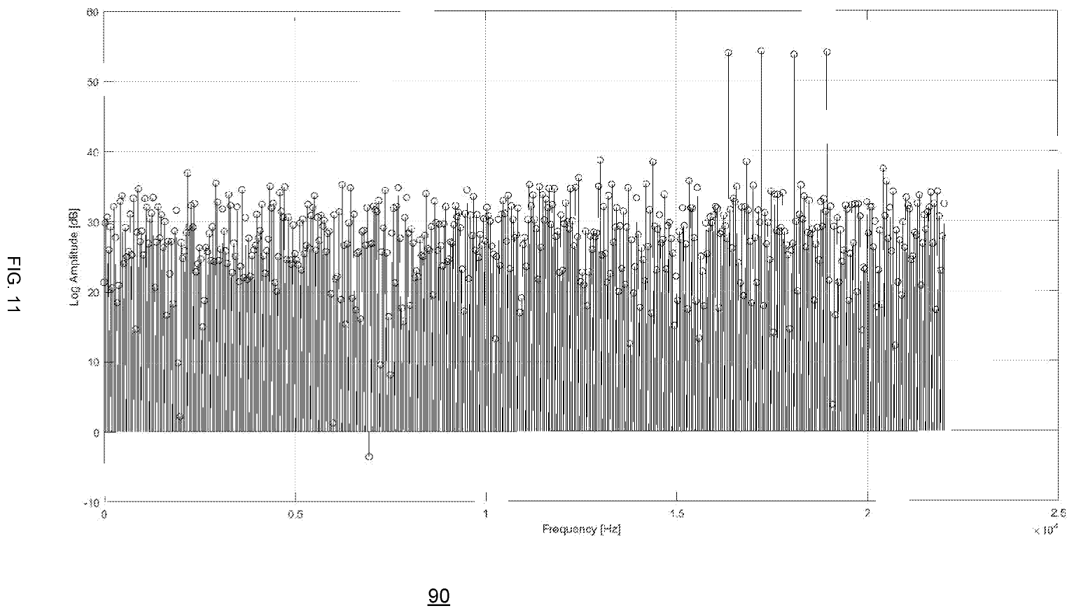

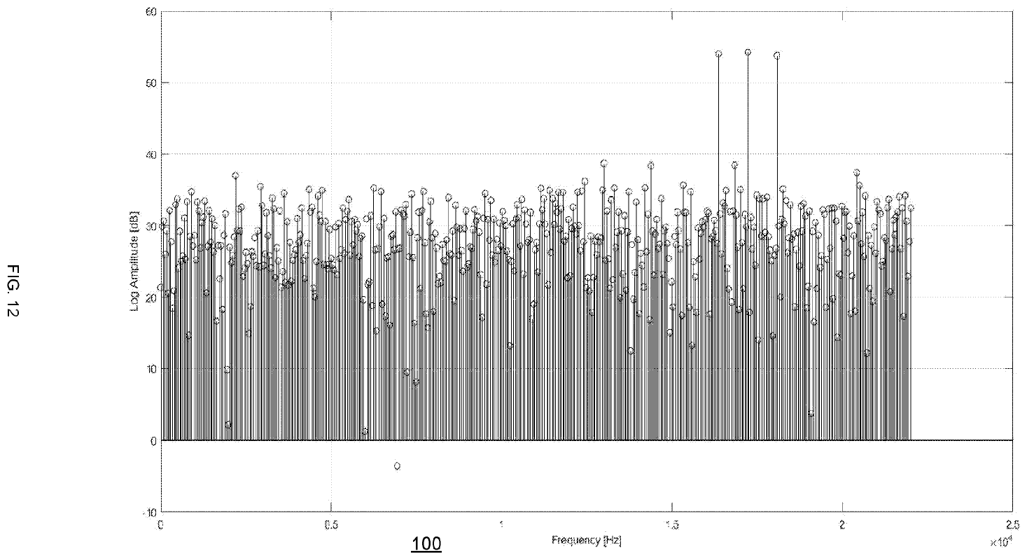

An example is provided in FIGS. 11 and 12, demonstrating that in the presence of high noise it is possible to distinguish between transmission of Symbol encoded with K=4 vs. Symbol encoded with K=3.

FIG. 11 illustrates the spectrum 90 (outcome of the spectral Analysis at the Receiver) of a Symbol with Additive Noise, K=4 N=16, where Fₛ=44100 [Hz], L=1024

FIG. 12 the spectrum 100 (outcome of the spectral Analysis at the Receiver) of a Symbol with Additive Noise, K=3 N=16, where Fₛ=44100 [Hz], L=1024.

There may be provided a method to overcome “Clicking” effect for the Transmitter. When consecutive R bits symbols are transmitted, annoying “Clicking” effect may sound, even when the Symbols are at an inaudible frequency range, since the K frequencies used for encoding consecutive Symbols may not all be the same, and the abrupt transition between frequencies may cause a “Clicking” effect.

To mitigate the “Clicking” effect due to frequency transition between Symbols, a method of smooth transition is described, where the frequency is gradually increased or decreased at the end of an encoded Symbol and accordingly decreased or increased at the beginning of the consecutive encoded Symbol.

Accordingly, if the frequency f₁ is of the K frequencies used to encode a Symbol in a message and f₂ is of the K frequencies used to encode the consecutive Symbol, then in the transition time, typically ⅛ (or less than ½) of a symbol duration, the frequency is gradually changed from f₁ to f₂.

This clicking mitigation may be included in method 200.

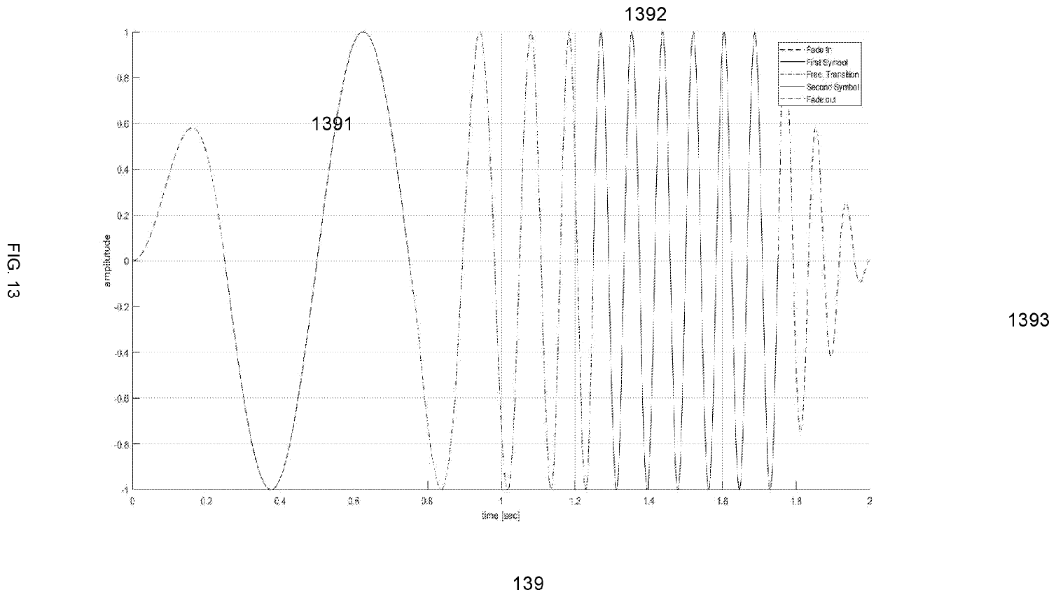

FIG. 13 includes a graph 139 that illustrates the gradual frequency change 1392 of frequency—a smooth transition between frequencies of two consecutive encoded Symbols with K=1.

At the start and at the end of the whole transmission “Clicking” effect may sound due to the sudden actuation and in-actuation of the Transmitter Loudspeaker. To mitigate the “Clicking” effect due to Loudspeaker actuation and in-actuation, “Fade In” is applied at the beginning of the first transmitted encoded Symbol of a message, and “Fade Out” is applied at the end of the last transmitted encoded Symbol of a message.

FIG. 13 also shows a Fade In 1391 of the first encoded Symbol, frequency transition 1391 between encoded Symbols, and Fade Out 1393 at the end of the last encoded Symbol. In this example K=1, and encoded Symbol duration is 1 Second.

For messages composed of several consecutive Symbols, error detection and correction methods such as CRC (Cyclic Redundancy Code) or Reed-Solomon can be applied to verify the integrity of a received message and in order to correct errors. Accordingly, error detection and correction Symbols may be appended to messages by the Transmitter and used by the Receiver.

A method may be provided to overcome frequency inaccuracy of Clocks sources of devices. Inaccurate Clocks sources may cause inaccurate Sampling Clocks rates of the Receiver or the Transmitter. The result of inaccurate Sampling Clocks rates is that the transmitted or received encoded Symbols are shifted in the frequency domain, and appear on the wrong frequency bin or smeared over several frequency bins following Spectral analysis, and are thus not decoded properly.

A frequency shift due to inaccuracy of δ% of the Sampling Clocks frequency will cause frequency fₙ to be shifted by

$$Δ {f}_{n} = \frac{( 1 + \frac{δ}{100} ) {F}_{s}}{N} - \frac{{F}_{s}}{n} = \frac{{δF}_{s}}{100 N} .$$

To overcome this problem, the Receiver shall shall average adjacent frequency bins following Spectral Analysis, or try several “Hypotheses” for the N frequencies Spectral locations.

In each hypothesis tried, the receiver shall perform a frequency shift, and then test the message CRC to verify whether this frequency shift has provided a correct decoding.

To mitigate Inaccurate Clocks sources through averaging, the receiver shall average the energy of f_{q-1}, f_{q} and f_{q+1} (rather than f_{q} only) in order to determine the energy of each of the N frequencies used in the Unmodulated Multi Carrier scheme.

A frequency shift Hypothesis which provides correct decoding verified by the message CRC, shall be considered to have resolved the frequency shift issue. Otherwise other Hypotheses with different frequency shift values shall be tried. In order to perform the frequency shift per hypothesis, two methods are provided herein. Either one of these methods (or any combination) may be included in method 210.

The first method is referred to as “Coarse” frequency shift, whereby the Receiver, instead of measuring the energy of N frequencies subset of {f_{q}}, measures the energy of N frequencies with indexes f_{q+m}. Positive or negative integer values of m determine the frequency shift per hypothesis. As an example, for K=1, and N=4 and transmitting one out of the set of frequencies [f₈, f₁₀, f₁₂, f₁₄] per Symbol, a shift by m=3 will dictate measuring the energies of received frequencies [f₁₁, f₁₃, f₁₅, f₁₇].

The second method is referred to as “Fine” Frequency shift, and is applied prior to performing Spectral Analysis by vector dot product of the L samples block with L complex values of an exponential series

$$z [ l ] = {e}^{- i \frac{2 π∞ l}{L}}$$

where l=[0, 1, . . . , L−1], ≤∝≤1, i=\sqrt{−1}

Using this method, the value of ∝ determines a fine shift value between f_{q-1} and f_{q+1} for all frequencies. Following the vectors dot product operation, the Receiver shall measure the energy of the original N frequencies indexes in the product vector.

The coarse frequency shift is simple, exhibits a wide span of frequency shifts and low computational complexity. The disadvantage of the coarse frequency shift is low resolution of frequency shift, which results in performance degradation.

The fine frequency shift provides high resolution frequency shifts, with a disadvantage of smaller range of frequency shifts and higher computation complexity. The coarse and fine frequency shifts can be combined to achieve wide range of frequency shifts in high resolution by initially applying the coarse frequency shift to achieve a coarse frequency shift and then applying the fine frequency shift to fine tune the coarse shifted signal in the frequency domain

Another method to overcome frequency shift due to inaccurate Clocks frequencies is to transmit each message several times, each time with another value of frequency shift, by using the frequency shift methods described above at the Transmitter and converting the frequency shifted symbols back to the time domain. This method may be included in method 200.

The Receiver shall decode the received messages and consider only messages with correct CRC. This method relives the computational burden of the receiver, and may be used to compensate for the Clocks frequency inaccuracy of the Transmitter or of the Receiver or both. This method is particularly suitable for receiving devices with low computation power. The disadvantage of this method is that each message shall be transmitted several times, extending the time required for communication accordingly. This may be included in method 210.

In case that a Transmitter or a Receiver are moving relative to each other, Doppler Effect is causing a shift in the frequencies of the signal received according to:

$${f}_{m} = {f}_{n} ( \frac{c - v}{c} )$$

where fₙ is a frequency component of the Symbol transmitted by the Transmitter, c is the speed of sound, v is the speed of the Receiver relative to the Transmitter, and fₘ is the frequency component fₙ of the Symbol, received by the Receiver. In order to mitigate Doppler Effect, the transmitter may add to each transmitted symbol a signal with frequency fₚ known to the Receiver, referred to as Pilot signal. The receiver may measure the received frequency fᵣ of the Pilot signal and determine its moving speed relative to the transmitter:

$$v = c ( 1 - \frac{{f}_{r}}{{f}_{p}} ) .$$

Doppler Effect fixing can be performed by the Receiver through submitting each of the K received frequencies of the Symbol in

$${f}_{n} = {f}_{m} ( \frac{c}{c - v} )$$

to determine the frequency set of the transmitted symbol.

A method for Single Symbol Communication is described. By using this method with proper selection of K and N, the amount of binary data which can be delivered by a single Symbol is sufficient for numerous connectivity applications such as IoT devices control, secured transactions keys exchange and telemetry data broadcast. The advantage of Single Symbol Communication is providing short communication time, being robust to echo and noise, and simple Receiver processing algorithm since there is no need for Receiver Symbols Timing synchronization with the Transmitter Symbols Timing. Communication between devices shall be considered to be Single Symbol Communication as long as the encoded Symbol is the same, even when it is transmitted repeatedly, possibly with silent periods between transmissions or when applying Frequency Hopping to consecutive transmissions. The duration of each transmission shall be sufficient for decoding a Symbol by a Receiver considering the ambient conditions. This single symbol communication may be included in methods 200 and 210.

A method may be provided for integration of Single Symbol Communication in systems containing Devices with Loudspeakers and Microphones such as Cellular Phones, which are connected to a computer network Cloud via data channels such as Wi-Fi or Cellular. This method overcomes the constraint of limited range and low rate data communication over an acoustic channel vs. broad range and high rate data communication provided by other networks, while keeping the advantage of locality provided by acoustic engagement between devices.

By this method, an Acoustic encoded Symbol referred to as “Beacon” is transmitted repeatedly from a Loudspeaker. Receiving devices within the transmitting device vicinity receive and decode the Beacon, and send its value via a network, such as the internet, to a Server. The Server responds via that network with the required actions to take place by the Devices, such as opening a web page on a browser or deduction of credit from an electronic wallet installed on the Devices.

The required action may be provided to the Devices by the Server beforehand, and written in tables on the Devices, providing for off-line operation and eliminating the need for continuous communication between the Devices and the Server in order for the Device to take action according to the value of the received Beacon. The Beacons Symbols of the transmitting devices and the actions tables on the receiving devices may be modified occasionally by the cloud server.

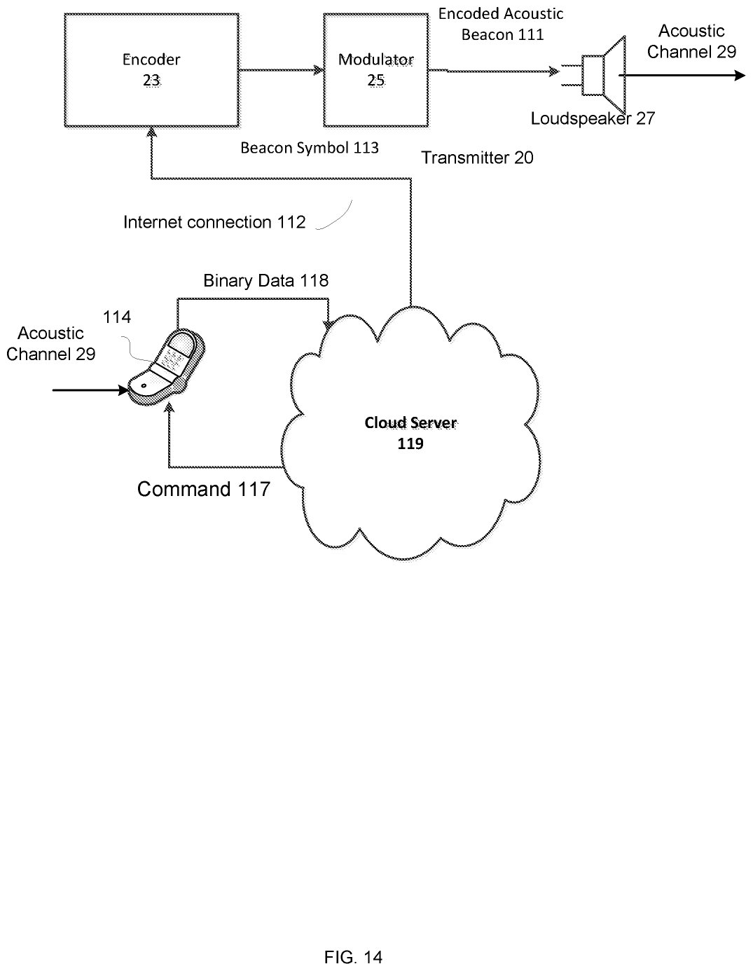

FIG. 14 depicts a configuration of such system and a Single Symbol Acoustic Communication with a Cellular Phone connected to a Cloud Server via the internet.

FIG. 14 illustrates a transmitter 20 as receiving a beacon symbol 113 (via internet connection 112) and transmits (over acoustic channel 29) a subset of K unmodulated acoustic carrier frequencies—to be received by mobile phone 114. Mobile phone 114 outputs binary data 118 to cloud server 119 and receives a command 117 from the cloud server.

A method may be provided for Second Factor Authentication through Single Symbol Communication. Among other applications, Second Factor Authentication is being used to secure monetary transactions over the internet, such as in e-Banking and e-Commerce. The common two factors in use are “what you know”—typically user ID and Password, and “what you have”—typically a physical device such as the user's cellular phone.

A code is sent from the e-Banking Server to the computer, and sounded as Acoustic Symbol through the computer Loudspeaker(s).

In parallel, the identity of the user's cellular phone is verified by the e-Banking Server through sending an SMS message containing a random, one-time code to the use's cellular phone over the Cellular network.

The e-Banking server expects to get the code of the Acoustic Symbol which was received by the cellular phone, along with the one—time code sent by SMS, in order to complete the authentication process.

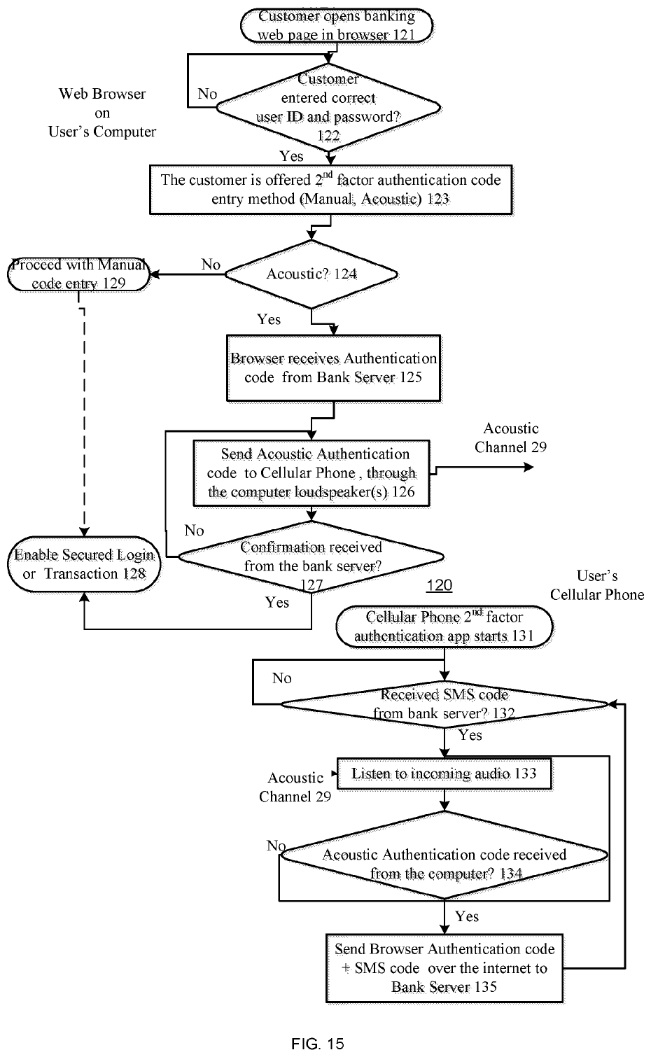

A flowchart of secured login to e-Banking services from a user's computer, with Second Factor Authentication through the user's Cellular Phone is depicted in FIG. 15.

Steps 121-129 are executed by a web browser on user's computer. Steps 131-135 are executed by the user's cellular phone.

Step 121 includes opening a banking web page in its computer browser.

Step 121 is followed by step 122 of performing a user ID and password based authentication.

If step 122 succeeds the method proceeds to step 123 of suggesting a second factor authentication method—out of a manual code entry and acoustic.

If acoustic (checked in step 124—following step 123) the jumping to step 125—and if selecting the manual code entry, then jumping to step 129.

Step 129 includes performing a manual code entry authentication—and if successful the jumping to step 128 of enabling secured login or transaction.

Going back to the acoustic option—step 125 includes receiving by the browser an authentication code (from the bank server).

Step 125 is followed by step 126 of sending an acoustic authentication code to Cellular Phone, through the computer loudspeaker(s).

The method may also include step 127 of waiting for confirmation from the bank server and moving to step 128 once the user part was completed successfully.

At the user's cellular phone:

Step 131 includes initializing the second factor authentication.

Step 131 is followed by step 132 of checking of an SMS message was received from the bank server.

When such an SMS message was received then listening to incoming audio (133) and checking (134) whether an acoustic authentication code (transmitted at step 126) was received.

After such an acoustic authentication code is received then sending (135) information about the browser authentication code (included in the acoustic authentication code) and about the SMS code over the internet to a bank server.

There may be provided a method of “Audio Annotation”, referring to embedding encoded digital information in an Analog audio signal. The Annotation is performed by adding Acoustic encoded Symbols to the audio signals. Among the applications of this method are annotating audio tracks including broadcasted or recorded audio.

Decoding Annotated audio by Receivers may be used to promptly and uniquely identify an audio track. The Receivers may be part of applications, including applications for Cellular phones which communicate with and deliver the decoded Symbols data to Servers.

The frequency range of the Acoustic encoded Symbols which annotate the audio signals may be at an inaudible frequency range, so that the Annotation is not perceived by a human listener. Optional amplitude modulation of the annotating audio in proportion to the amplitude of the annotated audio signal shall keep the annotating audio instantaneous energy below the instantaneous energy of the annotated audio, and provide further hiding of the annotating signal from a human listener. The ratio between the annotating audio signal energy and the annotated audio signal energy is tuned to a level which provides proper decoding by a Receiver considering ambient conditions such as attenuation, noise and Loudspeakers and Microphones characteristics.

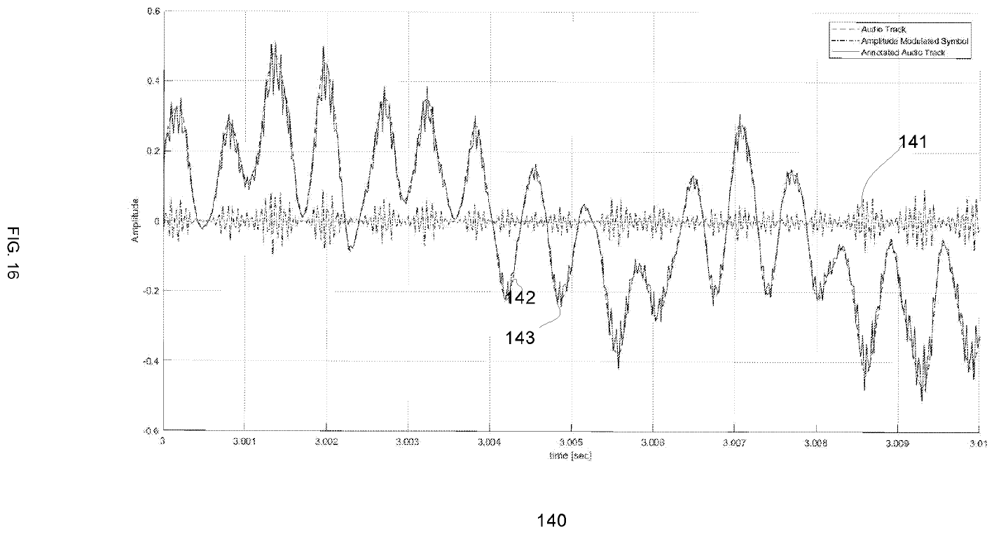

FIG. 16 depicts Unmodulated Multi Carrier symbol Annotation of a Commercial audio signal while applying Amplitude Modulation to the encoded Symbol proportional to the Commercial audio signal instant energy.

FIG. 16 illustrates Unmodulated Multi Carrier symbol 141, audio track 142 and annotated audio track 143. Annotation of audio track with encoded Symbol, K=2, N=8. To provide further hiding from a human listener, the encoded Symbol is Amplitude Modulated.

A method may be provided for Acoustic based Positioning of devices, including but not limited to areas where GPS signals are not received. The method is based on the fact that Acoustic wave's propagation is limited by distance as well as by walls, doors and deflecting or absorbing materials. Thus, relative or absolute positioning is provided by using acoustic waves for Connectivity and Positioning. Use cases of the described method include, but are not limited to, location based access to office apparatus such as desk phones including IP phones, shared printers, copy machines and IoT (Internet of Things) devices such as IoT Door Locks.

The described method can as well be applied for in-building navigation, users location monitoring and for providing location based services. Devices may send and receive information related to their position through other data networks and Servers, in addition to the signals and data sent via the acoustic channel. When one or more devices has a known position, and one or more devices are with unknown position, a method and system may be provided to locate devices with unknown positions. Acoustic Interface may already exist in devices such as cellular phones, doors intercoms or office phones and be used for other purposes. In such case, the value added by applying the described method can be achieved as software upgrade to an existing install base, with no additional hardware cost. Alternatively, Acoustic Interface may be installed for the purpose of Connectivity or Positioning in or near devices without acoustic interface such as office printers, or within employee badges.

The method for Positioning is based on repeatedly transmitting an encoded Symbol referred to as “Beacon”, having a unique value referred to as “Device ID”. The Beacon duration shall be sufficient for detection by a receiving device, typically between 0.2-0.8 seconds.

A device in the vicinity of the transmitting device may receive the Beacon, and decode the Device ID. In order to provide immunity to false detection of Device IDs, the receiving device may use a criterion where the same Device ID shall be received repeatedly for a pre-defined number of times or be statistically dominant.

By decoding a Beacon, the receiving device can determine that it is located in the vicinity of a transmitting device, and the device ID of the transmitting device.

Once the device ID of a transmitting device with a known position is decoded by a receiving device in its vicinity, the receiving device may determine its own approximated position.

For that purpose the receiving device either keeps a local record of Device IDs of devices which have a known position and their positions, or receives the position of a detected device ID through direct connection with the device which has a known position, or receives the position through connection with a Server, that keeps Device ID records of devices which have a known position, and their positions.

In case that several transmitting devices are in the vicinity of a receiving device, the receiving device may decode several Beacons. In such case, the energy of a received Beacon is used to determine its relative proximity to the transmitting device, by comparing the received Beacon energy to the energy of the other Beacons received.

In order to minimize the effect of collisions of Beacons transmitted by several devices in the vicinity of each other, a transmitting device may transmit its Beacon repeatedly with silent periods of random time length between transmissions, to occasionally provide the other transmitting devices clear acoustic channel for their transmission.

Another method to avoid collisions of Beacons transmitted by several devices in the vicinity of each other is that the Transmitter shall verify prior to transmission, by using its own Microphone, that no other Beacon is transmitted at the moment and thus the Acoustic channel is free. The Transmitter shall commence transmission only when the Acoustic channel is determined to be unused by other Transmitters. This method withstands and can be applied along other collision avoidance methods.

Another method to avoid collisions between Beacons transmitted by several devices in the vicinity of each other is that the transmitting devices in the vicinity of each other shall use different and mutually exclusive N frequencies subsets of the {f_{q}} frequency set which are on the DFT grid of the receiving devices. The receiving devices shall detect different Symbols within different subsets of frequencies.

Once a device position is determined, Position Based Services can be provided. Such services include printing a documents with a shared printer nearest to a user whose position is determined by positioning a user's personal device such as cellular phone.

Acoustic Connectivity and Positioning can be used for dialing a number from a cellular phone contacts list, through an IP phone.

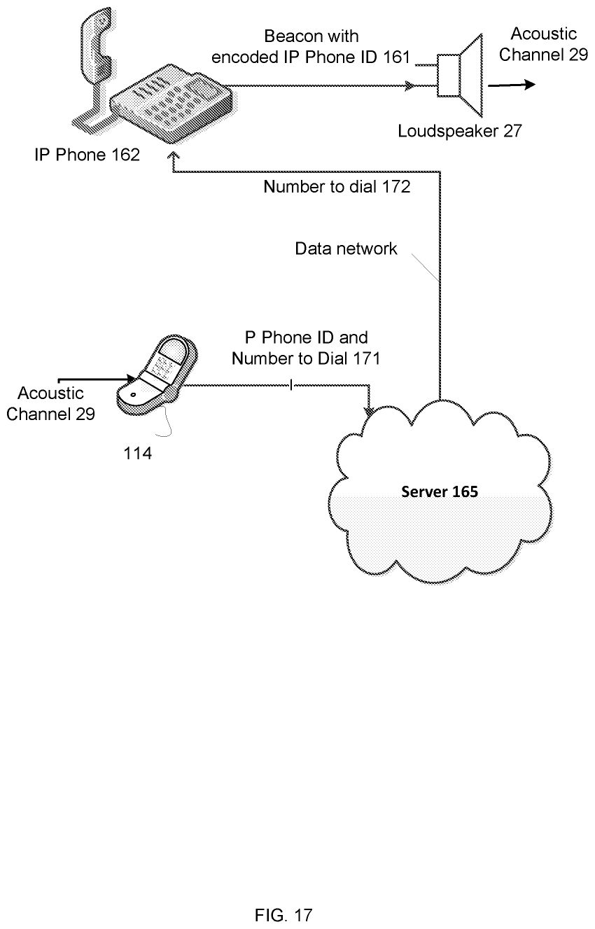

As depicted in FIG. 17, an IP phone 162 repeatedly transmits a Beacon which encodes its unique ID (“beacon with encoded IP phone ID” 161).

A cellular phone 114 which is in its vicinity receives and decodes the IP phone ID 161 and sends it via a data network to an IP Telephony Server along with the requested number to dial.

The server then instructs the IP phone to make a phone call to the requested number (“number to dial” 172). The described method saves IP phone users the tedious process of manually copying a number to dial from the cellular phone contacts to the IP phone keypad, and provides means to construct IP Phones without display or keypad.

Acoustic engagement between cellular phones and IP phones which provides users positioning may as well provide the “follow me” feature, where incoming phone calls to a user through IP Telephony network are directed automatically to the IP phone which is nearest to the user.

There may be provided a method for in-building navigation based on the fact that desk IP phones are stationary while people carry their cellular phones with them. Beacons for Positioning are transmitted through the desk IP Phones Loudspeakers, and received by the users' cellular phones Microphones. The IP phone ID and the IDs of the cellular phone in its vicinity are uploaded (by the cellular phone) to a Server, which sends position information to the cellular phones. This position can be displayed on the cellular phone screen either by text message or on a map. Navigation instructions to a destination can be provided as well.

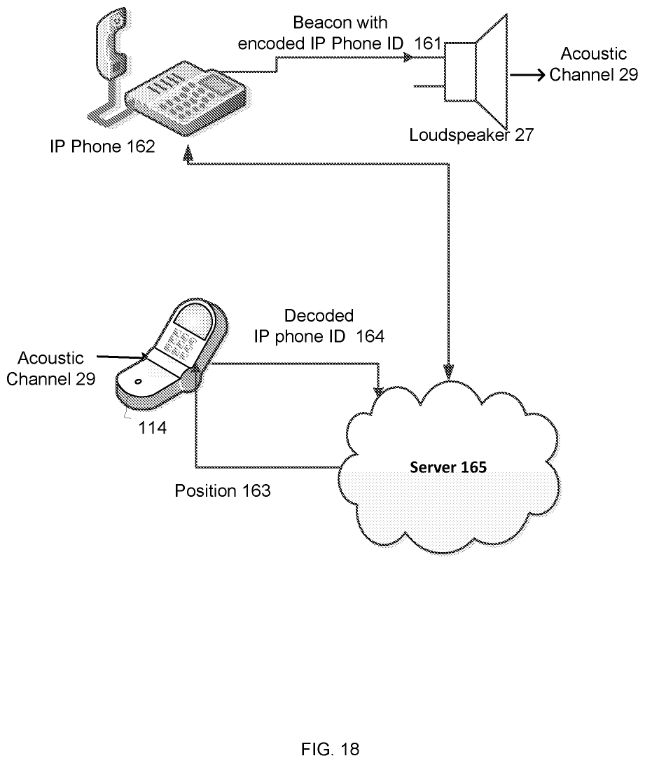

FIG. 18 illustrates an IP phone that outputs (via his loudspeaker) a beacon with encoded IP phone ID, that is received by mobile phone 114, that sends the decoded IP phone ID 164 to a server 165—and receives from the server the position 163 of the IP phone 162.

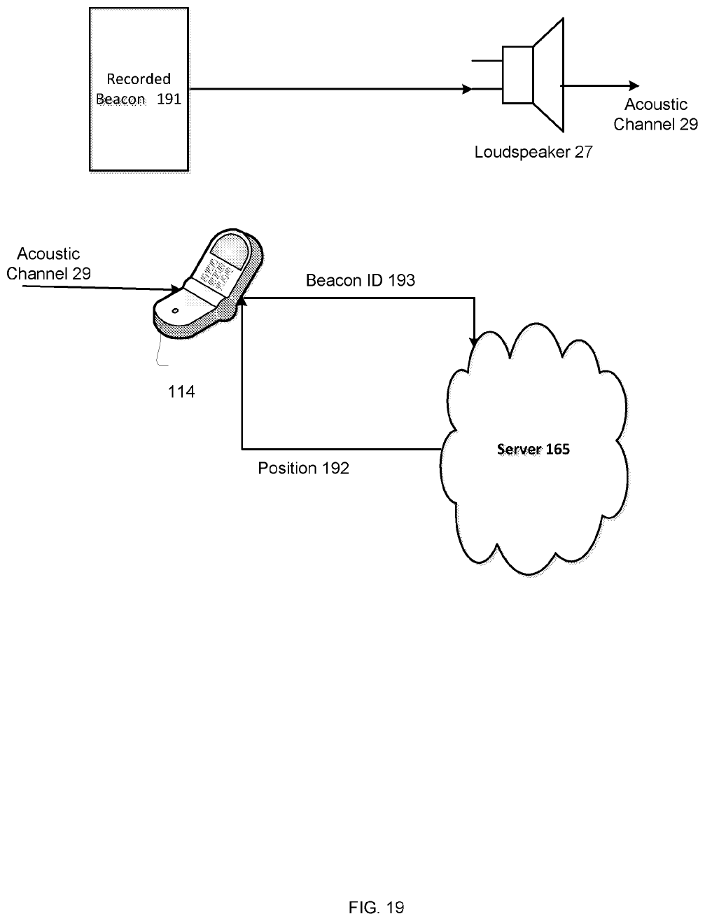

The source of Beacons for in-building navigation can be stationary Loudspeakers installed in rooms, corridors or in open areas, without the need to connect the Loudspeakers to a Server. The Loudspeakers repeatedly transmit unique pre-recorded encoded Beacons, which are received by the users' cellular phones or other personal devices connected to a server. This method provides a cost-effective solution for In-Building navigation since the Beacons hardware is inexpensive. FIG. 19 depicts the configuration of such system.

In FIG. 19 a recorded beacon 191 is fed repetitively to a loudspeaker 27 and is transmitted over acoustic channel 29. The recorded beacon is received by mobile phone 114, that sends the recorded beacon ID 193 to a server 165—and receives from the server the position 192 of the loudspeaker 27.

Positioning of mobile devices such as cellular phones, laptop computers and tablets can be used to identify and report attendee's presence in conference rooms, notify the other attendees who is present, and serve to save energy by controlling light and air-conditioning according to the number of people in a room. Additionally it can be a means for users to locate each other.

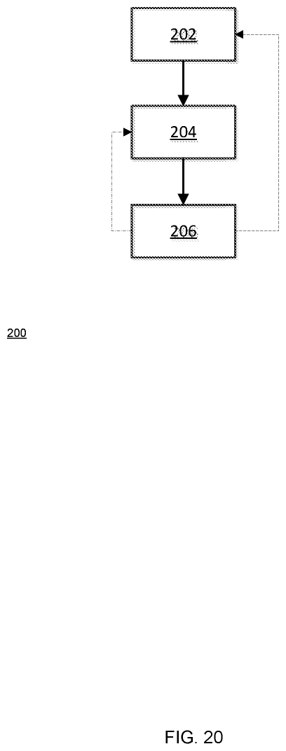

FIG. 20 illustrates an example of method 200.

Method 200 may include steps 202, 204 and 206.

Step 202 may include receiving or generating a symbol of R bits. R may be of any value—for example—it may exceed four.

Step 204 may include selecting a subset of K audio carrier frequencies that represent the symbol. The subset is selected out of a set of N audio carrier frequencies. The values of R, N and K may fulfill the following condition

$$R = Floor ( {Log}_{2} ( \frac{N !}{K ! ( N - K ) !} ) ) .$$

Floor is a floor function and Loge is a base two logarithm.

Step 206 may include concurrently transmitting the subset.

The subset includes acoustic signals. The value of the symbol is represented by the identity of the audio carrier frequencies—and in this sense the subset may be regarded as a subset of unmodulated audio carrier frequencies. The subset may be modulated (for example for reducing “clicking” sounds)—but the modulation may not convey information about the symbol.

Each audio carrier frequency of the subset may represent a set bit of the symbol.

A value represented by the set bit is responsive to an order (k) of the set bit within the K set bits of the symbol, and to an order (n) of the set bit within the set of N audio carrier frequencies; wherein for k that ranges between 1 and K and for n that ranges between 0 and N−1, the value of the set bit is zero for n that is smaller than n, is one for n=k, and for n that exceeds k is

$$( \frac{n !}{k ! ( n - k ) !} ) .$$

Step 204 may include determining, which bit to set to provide K set bits by accessing a mapping that maps values of the set bit to values of n and k.

Step 204 may include:
1) Finding a group of pairs of N and K values that fulfill

$$R = Floor ( {Log}_{2} ( \frac{N !}{K ! ( N - K ) !} ) ) .$$

2) Finding a sub-group of pairs of N and K that include a smallest value of K.
3) Selecting, from the sub-group, a pair that includes the smallest value of K and a smallest value of N.

Each audio carrier frequency may equal

$$q \cdot \frac{{F}_{s}}{L} ;$$

wherein Fₛ is a sampling rate of a receiver that is scheduled to receive the set, L is a number of samples in a receiver spectral analysis block, and q exceeds zero and is smaller than a half of L. When this condition is fulfilled the audio carrier frequencies are on the Receiver DFT grid.

The method may include changing a value of R to provide a new value of R, and determining N and K in response to the new value of R. Thus, one or more symbols may be of a first length (current R value), R may be changed and one or more other symbols may be of a second length (new R value). The change of R may be performed for various reasons such as changed in the channel, changes in throughput constraints, and the like.

The symbol may include data bits and error detection bits. The error correction bits may be CRC bits.

The duration of the symbol transmission may range between 0.1 and 4 seconds. The duration may be shorter than 0.1 seconds and may exceed 4 seconds.

Method 200 may be repeated multiple times for single symbol transmission or for transmitting different symbols.

The same symbol may be transmitted multiple times (repeating steps 204 and 206)—in the same manner or in a varying manner. Frequency hopping may involve changing the mapping between the same symbol and the subsets.

When the same symbol is transmitted multiple times, step 204 may include selecting subsets of K audio carrier frequencies that represent the symbol. Each subset may belong to a different set of N audio carrier frequencies. Step 206 will include transmitting the subsets, one subset at a time.

Different symbols may be transmitted by repeating steps 202-206.

Multiple repetitions of step 202 may amount to receiving or generating multiple symbols of R bits.

Multiple repetitions of step 204 may amount to selecting multiple subsets of K audio carrier frequencies that represent the multiple symbols.

Multiple repetitions of step 206 may amount to transmitting the multiple subsets, one subset at a time; wherein a transmission of each subset may include concurrently transmitting a subset that represents the symbol.

Step 206 may include gradually changing frequencies between a given subset to another subset that follows the given subset, the other subset may differ by at least one audio frequency carrier from the given subset. A non-limiting example is illustrated in FIG. 13—especially gradual frequency change 1392.

Step 204 may include selecting the multiple subsets so that the multiple subsets belong to the set of N audio carrier frequencies.

Step 204 may include selecting the multiple subsets so that at least two subsets of the multiple subsets belong to different sets of N audio carrier frequencies. The different sets of N may be mutually exclusive.

Step 206 may include gradually increasing, at a start of the first subset, an amplitude of the first subset; and gradually decreasing, at an end of the last subset, an amplitude of the last subset. See, for example FIG. 13—especially Fade In and Fade Out.

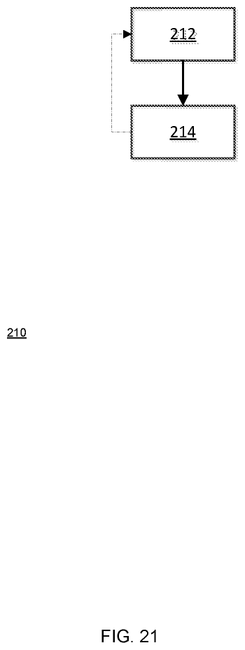

FIG. 21 illustrates an example of method 210.

Method 210 may include steps 212 and 214.

Step 212 may include concurrently receiving a subset of K carrier frequencies that represent a symbol of R bits. The subset was selected out of a set of N audio carrier frequencies.

$$R = Floor ( {Log}_{2} ( \frac{N !}{K ! ( N - K ) !} ) ) ;$$

Floor is a floor function, and Log₂ is a base two logarithm.

Step 212 may be followed by step 214 of reconstructing the symbol to provide a reconstructed symbol, based on the subset.

Steps 212 and 214 may be repeated multiple times.

Step 212, when repeated multiple times, may amount to receiving multiple subsets of concurrently transmitted K carrier frequencies, one subset at a time. The multiple subsets may represent multiple symbols. Each subset was selected out of a set of N audio carrier frequencies.

Step 214, when repeated multiple times, may amount to reconstructing each one of the multiple symbols based on the multiple subsets.

At least two subsets of the multiple subsets may belong to different sets of N audio carrier frequencies.

Each audio carrier frequency of the subset (received during step 212) may represent a set bit of the symbol. A value represented by the set bit is responsive to an order (k) of the set bit within the K set bits of the symbol, and to an order (n) of the set bit within the set of N audio carrier frequencies. For k that ranges between 1 and K and for n that ranges between 0 and N−1, the value of the set bit is zero for n that is smaller than n, is one for n=k, and for n that exceeds k is

$$( \frac{n !}{k ! ( n - k ) !} ) .$$

Step 214 may include calculating a value of the reconstructed symbol by accessing, for each set bit, a mapping between a value represented by the set bit and values of k and n. See, for example, table 3.

Each reconstructed symbol may include reconstructed data bits and reconstructed error detection bits. Step 214 may include performing error detecting using the reconstructed error detection bits.

Step 214 may include (a) selecting K frequency components of a spectrum of the subset of K carrier frequencies as set bits of a suggested symbol; (b) performing error detection on the suggested symbol; (c) wherein if the error detection indicated that the suggested symbol is erroneous—then replacing at least one selected frequency component by another frequency component that was not previously selected thereby providing a newly selected symbol and performing error detection on the newly suggested symbol.

Method 210 may include detecting K—even without prior knowledge of the value of K. Step 214 may include setting K to a number of frequency components, in the spectrum of the set of N carrier frequencies, having an intensity that exceeds a predefined intensity threshold.

Methods 210 and/or method 200 may be a part of various methods for authentication, location determination, and the like. See, for example, FIGS. 14-19.

For example—method 200 may include transmitting over a non-audio link, information about the reconstructed symbol. This step may be a part of a method executed by the system of FIG. 14—especially when the reconstructed symbol received by mobile phone 114 (over acoustic channel) includes binary data 118 that once received by the could server 119 causes the cloud server to issue a command 117 to the mobile phone.

The reconstructed symbol may embed a command executable by a remote computer.

Referring to FIG. 15—step 126 of method 120 may include transmitting an acoustic authentication code that includes one or more symbols—using method 200. In addition—steps 133 and 134 of method 120 include receiving and reconstructing the acoustic authentication code using method 210.

Methods 200 and 210 may be used for annotation of an audio signal by any modulated encoded symbol—such as an amplitude modulated encoded symbol. Referring to FIG. 16—method 210 may be used for concurrently receiving (and later on reconstructing) the subset of K carrier frequencies and additional audio signals. The reconstructed symbol may include metadata regarding the additional audio signals.

Methods 200 and 210 may be used in the scenario illustrated in FIG. 17. The transmitter may be an internet protocol phone that transmits (by applying method 200) a symbol (beacon 161) that may include information about an identity of the internet protocol phone.

A cell phone 114 may receive the symbol (and apply method 210) and obtain information about the identity of the internet protocol phone. The mobile phone then can supply to a remote computer the identity and a phone number of a target device (“IP Phone ID and Number to Dial” 171) and send a request, to the remote computer, to establish a communication session between the internet protocol phone and the target device. The remote computer (server 165) may send to the IP phone 162 a request (172) to dial to the requested number.

Methods 200 and 210 may be used in the scenario illustrated in FIGS. 18 and/or 19.

For example—the symbol may include information about a location and/or identity of the transmitter.

In FIG. 18 the symbol (beacon 161) may include information about an identity of the transmitter (IP phone). The method may include the obtaining information about the identity of the transmitter and calculating, based on the reconstructed symbol, a location of the receiver. The calculating may be done by the server and fed to the mobile phone 114.

Any reference to any of the terms “comprise”, “comprises”, “comprising” “including”, “may include” and “includes” may be applied to any of the terms “consists”, “consisting”, “and consisting essentially of”. For example—any of method describing steps may include more steps than those illustrated in the figure, only the steps illustrated in the figure or substantially only the steps illustrate in the figure. The same applies to components of a device, processor or system and to instructions stored in any non-transitory computer readable storage medium.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a computer program product. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as flash memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner Likewise, single connections carrying multiple signals may be separated out into various different connections carrying subsets of these signals. Therefore, many options exist for transferring signals.

Although specific conductivity types or polarity of potentials have been described in the examples, it will be appreciated that conductivity types and polarities of potentials may be reversed.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein may be designed as either negative or positive logic signals. Therefore, in alternate embodiments, those signals described as positive logic signals may be implemented as negative logic signals, and those signals described as negative logic signals may be implemented as positive logic signals.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for audio transmission, the method comprises:
receiving or generating a symbol of R bits;
selecting a subset of K audio carrier frequencies that represent the symbol; wherein the subset is selected out of a set of N audio carrier frequencies; and
concurrently transmitting the subset;
wherein
$$R = Floor ( {Log}_{2} ( \frac{N !}{K ! ( N - K ) !} ) ) ;$$
Floor is a floor function, and Log₂ is a base two logarithm.

2. The method according to claim 1, wherein each audio carrier frequency of the subset represents a set bit of the symbol; wherein a value represented by the set bit is responsive to an order (k) of the set bit within the K set bits of the symbol, and to an order (n) of the set bit within the set of N audio carrier frequencies; wherein for k that ranges between 1 and K and for n that ranges between 0 and N−1, the value of the set bit is zero for n that is smaller than n, is one for n=k, and for n that exceeds k is
$$( \frac{n !}{k ! ( n - k ) !} ) .$$

3. The method according to claim 2, comprising determining, which bit to set to provide K set bits by accessing a mapping that maps values of the set bit to values of n and k.

4. The method according to claim 1, comprising finding a group of pairs of N and K values that fulfill
$$R = Floor ( {Log}_{2} ( \frac{N !}{K ! ( N - K ) !} ) ) ;$$
finding a sub-group of pairs of N and K that include a smallest value of K; and selecting, from the sub-group, a pair that includes the smallest value of K and a smallest value of N.

5. The method according to claim 1, wherein each audio carrier frequency equals
$$q \cdot \frac{{F}_{s}}{L} ;$$
wherein Fₛ is a sampling rare of a receiver that is scheduled to receive the set, L is a number of samples in a receiver spectral analysis block, and q exceeds zero and is smaller than a half of L.

6. The method according to claim 1, wherein R exceeds four.

7. The method according to claim 1, comprising changing a value of R to provide a new value of R, and determining K in response to the new value of R.

8. The method according to claim 1, wherein the symbol comprises data bits and error detection bits.

9. The method according to claim 1, comprising concurrently transmitting the subset during a symbol transmission duration that ranges between 0.1 and 4 seconds.

10. The method according to claim 1, comprising:
receiving or generating multiple symbols of R bits;
selecting multiple subsets of K audio carrier frequencies that represent the multiple symbols; and
transmitting the multiple subsets, one subset at a time; wherein a transmission of each subset comprises concurrently transmitting a subset that represents the symbol.

11. The method according to claim 10, comprising gradually changing frequencies between a given subset to another subset that follows the given subset, the other subset differs by at least one audio frequency carrier from the given subset.

12. The method according to claim 10, wherein the multiple subsets belong to the set of N audio carrier frequencies.

13. The method according to claim 10, wherein at least two subsets of the multiple subsets belong to different sets of N audio carrier frequencies.

14. The method according to claim 10, wherein the multiple subsets start by a first subset and end by a last subset, wherein the method comprises: gradually increasing, at a start of the first subset, an amplitude of the first subset; and gradually decreasing, at an end of the last subset, an amplitude of the last subset.

15. The method according to claim 1, comprising:
selecting subsets of K audio carrier frequencies that represent the symbol; wherein each subset belongs to a different set of N audio carrier frequencies; and
transmitting the subsets, one subset at a time.

16. The method according to claim 1 further comprising transmitting, per symbol, a pilot signal of predefined frequency.

17. A method for audio reception, the method comprises:
concurrently receiving a subset of K carrier frequencies that represent a symbol of R bits; wherein subset was selected out of a set of N audio carrier frequencies; and wherein
$$R = Floor ( {Log}_{2} ( \frac{N !}{K ! ( N - K ) !} ) ) ;$$
Floor is a floor function, and Loge is a base two logarithm; and
reconstructing the symbol to provide a reconstructed symbol, based on the subset.

18. The method according to claim 17, wherein each audio carrier frequency equals
$$q \cdot \frac{{F}_{s}}{L} ;$$
wherein Fₛ is a sampling rate of the receiver, L is a number of samples in a receiver spectral analysis block, and q exceeds zero and is smaller than a half of L.

19. The method according to claim 17, comprising:
receiving multiple subsets of concurrently transmitted K carrier frequencies, one subset at a time; wherein the multiple subsets represent multiple symbols; wherein each subset was selected out of a set of N audio carrier frequencies; and
reconstructing each one of the multiple symbols based on the multiple subsets.

20. The method according to claim 19, wherein at least two subsets of the multiple subsets belong to different sets of N audio carrier frequencies.

21. The method according to claim 17, wherein each audio carrier frequency of the subset represents a set bit of the symbol; wherein a value represented by the set bit is responsive to an order (k) of the set bit within the K set bits of the symbol, and to an order (n) of the set bit within the set of N audio carrier frequencies; wherein for k that ranges between 1 and K and for n that ranges between 0 and N−1, the value of the set bit is zero for n that is smaller than k, is one for n=k, and for n that exceeds k is
$$( \frac{n !}{k ! ( n - k ) !} ) .$$

22. The method according to claim 21, comprising calculating a value of the reconstructed symbol by accessing, for each set bit, a mapping between a value represented by the set bit and values of k and n.

23. The method according to claim 17, wherein each reconstructed symbol comprises reconstructed data bits and reconstructed error detection bits; wherein the method comprises performing error detecting using the reconstructed error detection bits.

24. The method according to claim 17, comprising:
selecting K frequency components of a spectrum of the subset of K carrier frequencies as set bits of a suggested symbol;
performing error detection on the suggested symbol;
wherein if the error detection indicated that the suggested symbol is erroneous—then replacing at least one selected frequency component by another frequency component that was not previously selected thereby providing a newly selected symbol and performing error detection on the newly suggested symbol.

25. The method according to claim 17, comprising setting K to a number of frequency components, in the spectrum of the subset of K carrier frequencies, having an intensity that exceeds a predefined intensity threshold.

26. The method according to claim 17 further comprising transmitting over a non-audio link, information about the reconstructed symbol.

27. The method according to claim 26, wherein the reconstructed symbol embeds a command executable by a remote computer.

28. The method according to claim 17, further comprising receiving, over a non-audio-link message that comprises a verification code; generating information about the verification code and the reconstructed message.

29. The method according to claim 17, further comprising concurrently receiving the subset of K carrier frequencies and additional audio signals; wherein reconstructed symbol comprises metadata regarding the additional audio signals.

30. The method according to claim 17, wherein the symbol comprises information about a location of the transmitter.

31. The method according to claim 17, wherein the symbol comprises information about an identity of the transmitter; wherein the method comprises the obtaining information about the identity of the transmitter and calculating, based on the reconstructed symbol, a location of the receiver.

32. The method according to claim 17, wherein the transmitter is an internet protocol phone;
wherein the symbol comprises information about an identity of the internet protocol phone; wherein the method comprises:
obtaining information about the identity of the internet protocol phone;
supplying to a remote computer a phone number of a target device; and
sending a request, to the remote computer, to establish a communication session between the internet protocol phone and the target device.

33. The method according to claim 17 comprising sampling clock frequency inaccuracy compensation by evaluating different frequency shifted subsets of frequency components of a spectrum of the subset of K carrier frequencies.

34. The method according to claim 17 comprising averaging the frequency component amplitude with the amplitudes of adjacent frequency components on the receiver DFT grid.

35. The method according to claim 17 comprising receiving a doppler shifted version of the pilot signal and performing Doppler compensation to the subset of K carrier frequencies.

36. A computer program product that stores instructions for receiving or generating a symbol of R bits; selecting a subset of K audio carrier frequencies that represent the symbol; wherein the subset is selected out of a set of N audio carrier frequencies; and concurrently transmitting the subset; wherein
$$R = Floor ( {Log}_{2} ( \frac{N !}{K ! ( N - K ) !} ) ) ;$$
Floor is a floor function, and Log₂ is a base two logarithm.

37. A transmitter that comprise one or more circuits that are configured to (i) receive or generate a symbol of R bits; (ii) select a subset of K audio carrier frequencies that represent the symbol; wherein the subset is selected out of a set of N audio carrier frequencies; and (iii) concurrently transmit the subset; wherein
$$R = Floor ( {Log}_{2} ( \frac{N !}{K ! ( N - K ) !} ) ) ;$$
Floor is a floor function, and Log₂ is a base two logarithm.

38. A computer program product that stores instructions for concurrently receiving a subset of K carrier frequencies that represent a symbol of R bits; wherein subset was selected out of a set of N audio carrier frequencies; and wherein
$$R = Floor ( {Log}_{2} ( \frac{N !}{K ! ( N - K ) !} ) ) ;$$
Floor is a floor function, and Log₂ is a base two logarithm; and reconstructing the symbol to provide a reconstructed symbol, based on the subset.

39. A receiver, comprising one or more circuits that are configured to (i) concurrently receive a subset of K carrier frequencies that represent a symbol of R bits; wherein subset was selected out of a set of N audio carrier frequencies; and wherein
$$R = Floor ( {Log}_{2} ( \frac{N !}{K ! ( N - K ) !} ) ) ;$$
Floor is a floor function, and Log₂ is a base two logarithm; and (ii) reconstruct the symbol to provide a reconstructed symbol, based on the subset.
